(19) United States
(12) Patent Application Publication
(10) Pub. No.: US 2013/0325606 A1
(43) Pub. Date: Dec. 5, 2013

(54) METHOD AND APPARATUS FOR GENERATING AND PRESENTING REAL ESTATE RECOMMENDATIONS

(71) Applicant: VHT, INC., Rosemont, IL (US)

(72) Inventors: Brian Balduf, Algonquin, IL (US); Alex Zoghlin, Lake Forest, IL (US)

(73) Assignee: VHT, Inc., Rosemont, IL (US)

(21) Appl. No.: 13/633,591

(22) Filed: Oct. 2, 2012

Related U.S. Application Data
(63) Continuation-in-part of application No. 13/482,751, filed on May 29, 2012.

(51) Int. Cl. G06Q 30/02

(52) U.S. Cl. 705/14.53; 705/14.66

(57) ABSTRACT

Methods and apparatus for generating and presenting real estate recommendations are disclosed. The presently disclosed recommendation system processes a plurality of previously executed real estate transactions to create a knowledge database. The knowledge database stores correlations between real estate attributes, buyer attributes, advertiser attributes, and publisher attributes. The system correlates information about a buyer to information in the knowledge database and generates recommendations based upon a buyer profile and the knowledge database.

### PRIORITY CLAIM

This application claims priority to and the benefit as a continuation-in-part application of U.S. patent application Ser. No. 13/482,751, filed May 29, 2012, entitled “METHOD AND APPARATUS FOR REAL ESTATE CORRELATION AND MARKETING”, the entire contents of each of which are incorporated herein by reference and relied upon.

### BACKGROUND

When a potential home buyer is searching for a home, real estate websites often attempt to match existing listings to specific search criteria provided by the buyer.

However, not all buyers know what type of property they are looking to purchase. Some only have a vague notion of the type of property they want but are open to discovering different properties. Real estate websites may ask additional questions such as number of rooms, house size, etc. that a potential buyer wants, but this only serves to narrow the range of matching results.

However, the methods currently used to collect information and present real estate matches suffer from certain drawbacks. More specifically, real estate websites provide matches based on very limited information about the buyer, a limited scope of inputs and rudimentary data about the properties. As a result, the effectiveness of these methods is low and the results often have little relevance to the buyers.

### SUMMARY

The present disclosure provides new and innovative methods and apparatus for generating and presenting real estate recommendations.

In an example embodiment, a method of presenting real estate recommendations comprises: processing real estate information including sales of real estate properties to a first group of buyers of the real estate properties, the real estate properties having first real estate attributes and the first group of buyers having first buyer attributes; generating correlations between the first real estate attributes and the first buyer attributes; generating a knowledge database storing the processed real estate information, the first real estate attributes, and the first buyer attributes; receiving second buyer attributes about an active buyer; in response to receiving the second buyer attributes, updating the knowledge database based upon the second buyer attributes; determining an optimized real estate profile based upon the updated knowledge database and the second buyer attributes; and presenting the optimized real estate profile to the active buyer.

In another example embodiment, a method of processing real estate information including sales of real estate properties to first group of buyers of the real estate properties, the real estate properties having first real estate attributes and the first group of buyers having first buyer attributes; generating correlations between the first real estate attributes and the first buyer attributes; generating a knowledge database storing the processed real estate information, the first real estate attributes, and the first buyer attributes; receiving second buyer attributes about an active buyer; determining an optimized real estate profile based upon the knowledge database and the second buyer attributes; presenting the optimized real estate profile to the active buyer; updating the first buyer attributes based upon behavior of the first group of buyers; updating the knowledge database based upon the updated first buyer attributes; and updating the optimized real estate profile based upon the updated knowledge database.

### BRIEF DESCRIPTION OF THE DRAWINGS

FIG. 1 is a high level block diagram of an example communications system, according to an example embodiment of the present invention.

FIG. 2 is a more detailed block diagram showing one example of a computing device, according to an example embodiment of the present invention.

FIG. 3 is a flowchart of an example process for presenting an optimized real estate profile, according to an example embodiment of the present invention.

FIG. 4 is a flowchart of another example process for presenting an optimized real estate profile, according to an example embodiment of the present invention.

FIGS. 5A-5B are a list of example real estate attributes, according to an example embodiment of the present invention.

FIG. 6 is an example correlation matrix showing correlation combinations between various attributes, according to an example embodiment of the present invention.

FIG. 7 is a block diagram showing an example recommendation structure, according to an example embodiment of the present invention.

FIG. 8 is a block diagram showing an example data architecture, according to an example embodiment of the present invention.

FIG. 9 is a flow diagram illustrating an example process for generating real estate recommendations, according to an example embodiment of the present invention.

FIGS. 10 to 23 are example screenshots of one example embodiment of the present invention.

### DETAILED DESCRIPTION OF EXEMPLARY EMBODIMENTS

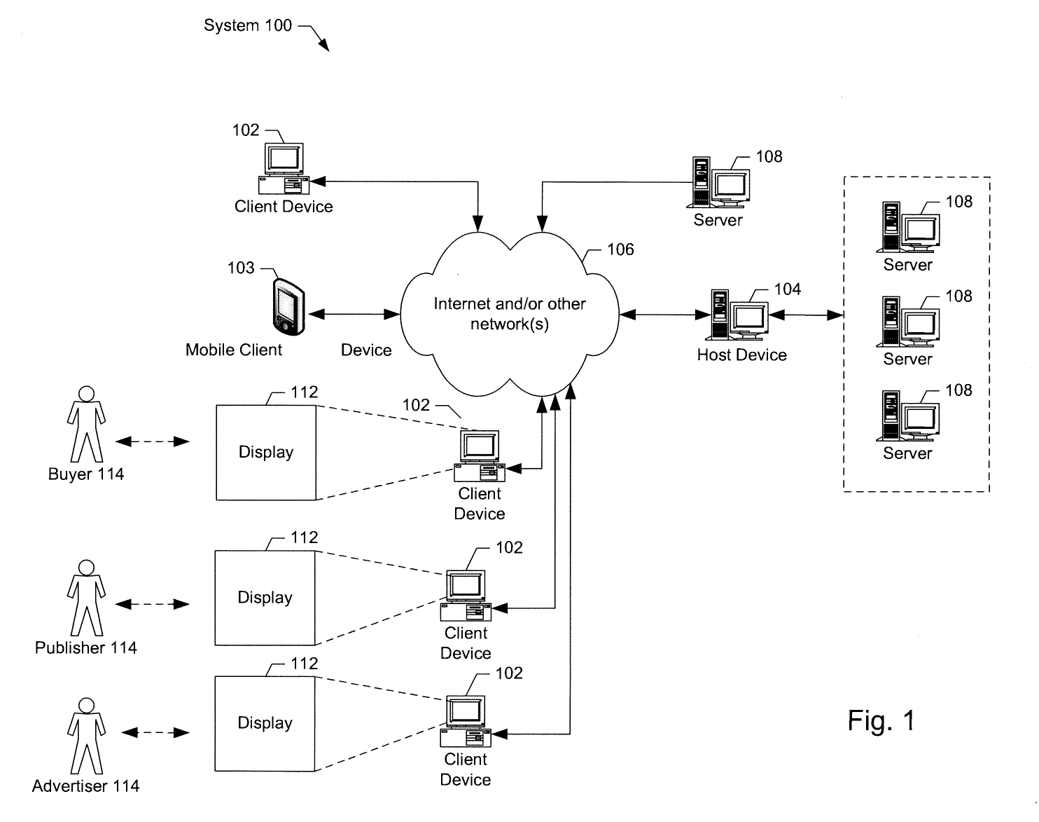

The present system may be readily realized in a network communications system. A high level block diagram of an example network communications system 100 is illustrated in FIG. 1. The illustrated system 100 includes one or more client devices 102, and one or more host devices 104. The system 100 may include a variety of client devices 102, such as desktop computers and the like, which typically include a display 112, which is a user display for providing information to users 114 of the recommendation system, such as buyers, publishers and/or advertisers, described below, and various interface elements as will be discussed in further detail below. A client device 102 may be a mobile device 103, which may be a cellular phone, a personal digital assistant, a laptop computer, a tablet computer, etc. The client devices 102 may communicate with the host device 104 via a connection to one or more communications channels 106 such as the Internet or some other data network, including, but not limited to, any suitable wide area network or local area network. It should be appreciated that any of the devices described herein may be directly connected to each other instead of over a network. Typically, one or more servers 108 may be part of the network communications system 100, and may communicate with host servers 104 and client devices 102.

One host device 104 may interact with a large number of users 114 at a plurality of different client devices 102. Accordingly, each host device 104 is typically a high end computer with a large storage capacity, one or more fast microprocessors, and one or more high speed network connections. Conversely, relative to a typical host device 104, each client device 102 typically includes less storage capacity, a single microprocessor, and a single network connection. It should be appreciated that a user 114 as described herein may include any person or entity which uses the presently disclosed recommendation system and may include a wide variety of parties. For example, as will be discussed in further detail below, users 114 of the presently disclosed recommendation system may include buyers, publishers and/or advertisers.

Typically, host devices 104 and servers 108 store one or more of a plurality of files, programs, databases, and/or web pages in one or more memories for use by the client devices 102, and/or other host devices 104 or servers 108. A host device 104 or server 108 may be configured according to its particular operating system, applications, memory, hardware, etc., and may provide various options for managing the execution of the programs and applications, as well as various administrative tasks. A host device 104 or server may interact via one or more networks with one or more other host devices 104 or servers 108, which may be operated independently. For example, host devices 104 and servers 108 operated by a separate and distinct entities may interact together according to some agreed upon protocol.

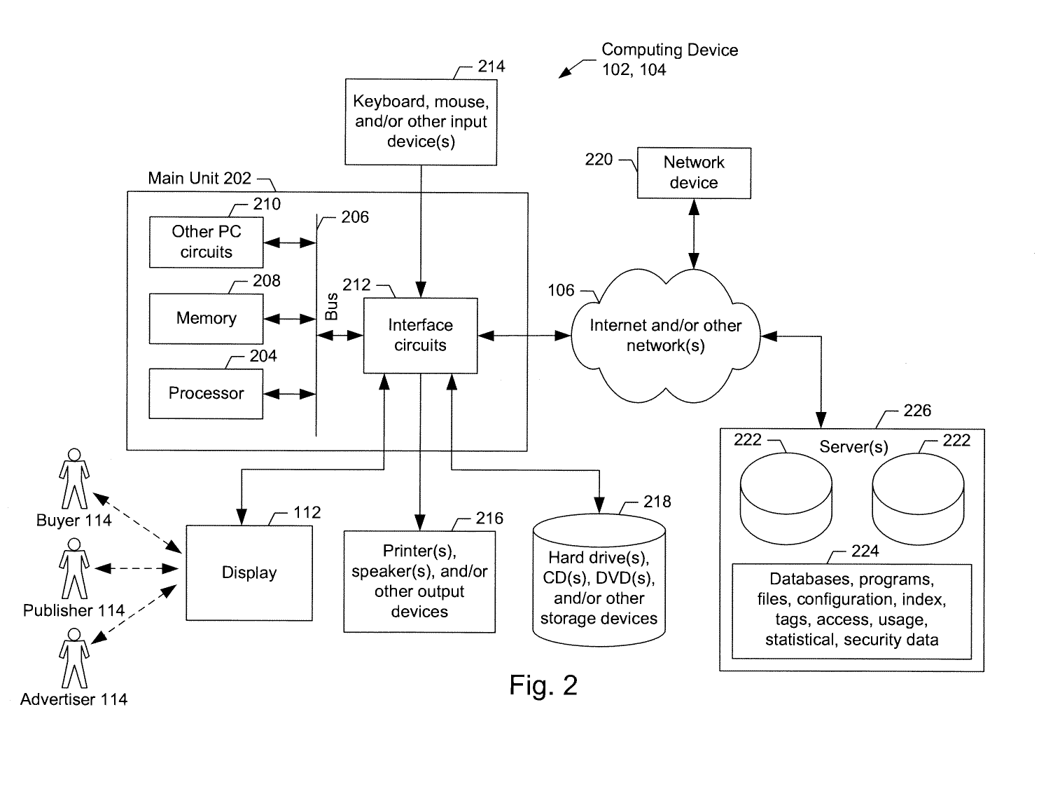

A detailed block diagram of the electrical systems of an example computing device (e.g., a client device 102, and a host device 104) is illustrated in FIG. 2. In this example, the computing device 102, 104 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100 as described below. This program may be executed by the processor 204 in any suitable manner. In an example embodiment, memory 208 may be part of a “cloud” such that cloud computing may be utilized by a computing devices 102, 104. The memory 208 may also store digital data indicative of documents, files, programs, web pages, etc. retrieved from a computing device 102, 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, image sensor, character recognition, barcode scanner, and/or a voice recognition system.

One or more displays 112, printers, speakers, and/or other output devices 216 may also be connected to the main unit 202 via the interface circuit 212. The display 112 may be a cathode ray tube (CRTs), a liquid crystal display (LCD), or any other type of display. The display 112 generates visual displays generated during operation of the computing device 102, 104. For example, the display 112 may provide a user interface, which will be described in further detail below, and may display one or more web pages received from a computing device 102, 104. A user interface may include prompts for human input from a user 114 including links, buttons, tabs, checkboxes, thumbnails, text fields, drop down boxes, etc., and may provide various outputs in response to the user inputs, such as text, still images, videos, audio, and animations.

One or more storage devices 218 may also be connected to the main unit 202 via the interface circuit 212. For example, a hard drive, CD drive, DVD drive, and/or other storage devices may be connected to the main unit 202. The storage devices 218 may store any type of data, such as pricing data, transaction data, operations data, inventory data, commission data, manufacturing data, image data, video data, audio data, tagging data, historical access or usage data, statistical data, security data, etc., which may be used by the computing device 102, 104.

The computing device 102, 104 may also exchange data with other network devices 220 via a connection to the network 106. Network devices 220 may include one or more servers 226, which may be used to store certain types of data, and particularly large volumes of data which may be stored in one or more data repository 222. A server 226 may include any kind of data 224 including databases, programs, files, libraries, pricing data, transaction data, operations data, inventory data, commission data, manufacturing data, configuration data, index or tagging data, historical access or usage data, statistical data, security data, etc. A server 226 may store and operate various applications relating to receiving, transmitting, processing, and storing the large volumes of data. It should be appreciated that various configurations of one or more servers 226 may be used to support and maintain the system 100. For example, servers 226 may be operated by various different entities, including automobile manufacturers, brokerage services, automobile information services, etc. Also, certain data may be stored in a client device 102 which is also stored on the server 226, either temporarily or permanently, for example in memory 208 or storage device 218. The network connection may be any type of network connection, such as an Ethernet connection, digital subscriber line (DSL), telephone line, coaxial cable, wireless connection, etc.

Access to a computing device 102, 104 can be controlled by appropriate security software or security measures. An individual users' 114 access can be defined by the computing device 102, 104 and limited to certain data and/or actions. Accordingly, users 114 of the system 100 may be required to register with one or more computing devices 102, 104. For example, registered users 114 may be able to request or manipulate data, such as submitting requests for pricing information or providing an offer or a bid.

As noted previously, various options for managing data located within the computing device 102, 104 and/or in a server 226 may be implemented. A management system may manage security of data and accomplish various tasks such as facilitating a data backup process. A management system may be implemented in a client 102, a host device 104, and a server 226. The management system may update, store, and back up data locally and/or remotely. A management system may remotely store data using any suitable method of data transmission, such as via the Internet and/or other networks 106.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

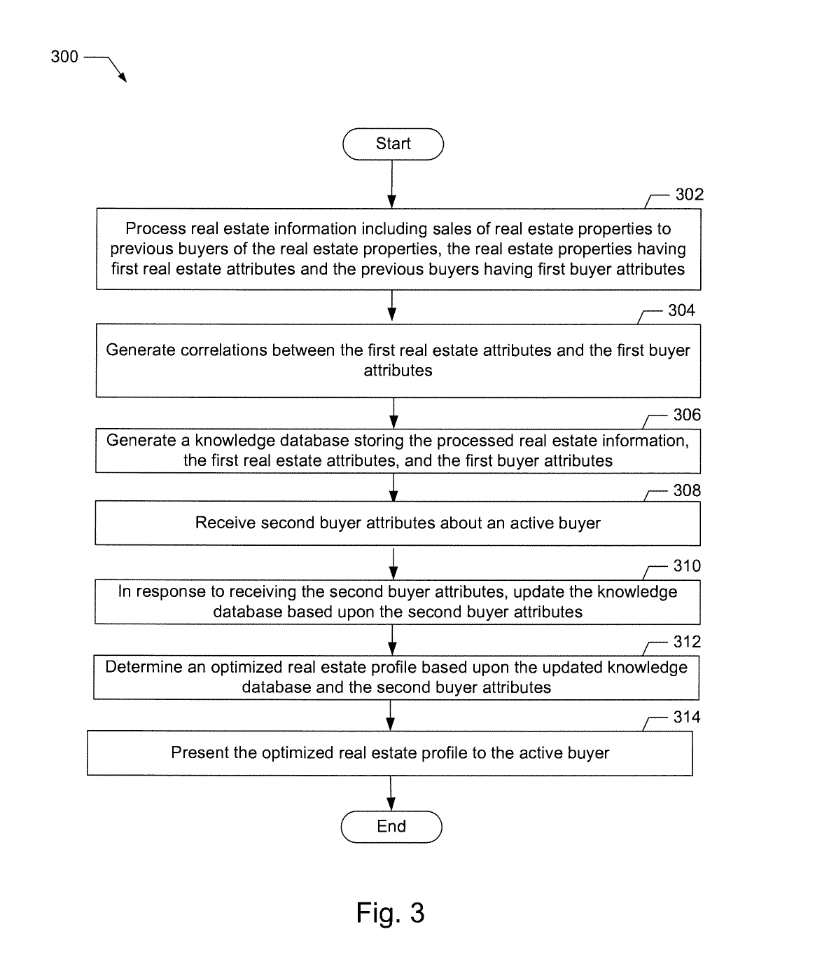

A flowchart of an example process 300 for presenting an optimized real estate profile is illustrated in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and many of the steps described are optional.

In general, the process 300 uses a plurality of previously executed real estate transactions to create a knowledge database. The knowledge database stores correlations between real estate attributes and buyer attributes. When an active buyer begins to search for a home, the recommendation system collects information about the active buyer and updates the knowledge database based on the information about the active buyer. The recommendation system then uses the knowledge database to determine an optimized real estate profile for the active buyer. At certain times, the knowledge database is updated to improve its accuracy.

It should be appreciated that in some instances, a “buyer” may include an “active buyer” who is actively looking for a home. “Buyers” may also include previous buyers, because buyers may buy homes multiple times. A “buyer” may include anyone whose information is part of the knowledge database. “Buyer” may also include potential buyers who end up purchasing a home, as well as potential buyers who do not purchase a home. For example, “buyer” may include an individual who intended to buy a home but does not buy a home because the individual decides to continue renting property instead of purchasing property.

The process 300 preferably begins by using a very large number of previously executed real estate transactions to create a knowledge database (block 302). The knowledge database generates correlations between real estate attributes and previous buyer attributes. For example, hundreds of thousands of previous real estate transactions and related data are preferably used to find relevant and significant correlations between each of these attributes. In addition, the real estate transaction data is preferably augmented with additional attributes from other data sources. For example, data associated with a particular buyer's interest may be gathered from a social networking website.

In one embodiment, the recommendation system correlates attributes from the knowledge database and searches through all of the real estate attributes stored in the knowledge database to create an ideal or optimized home profile.

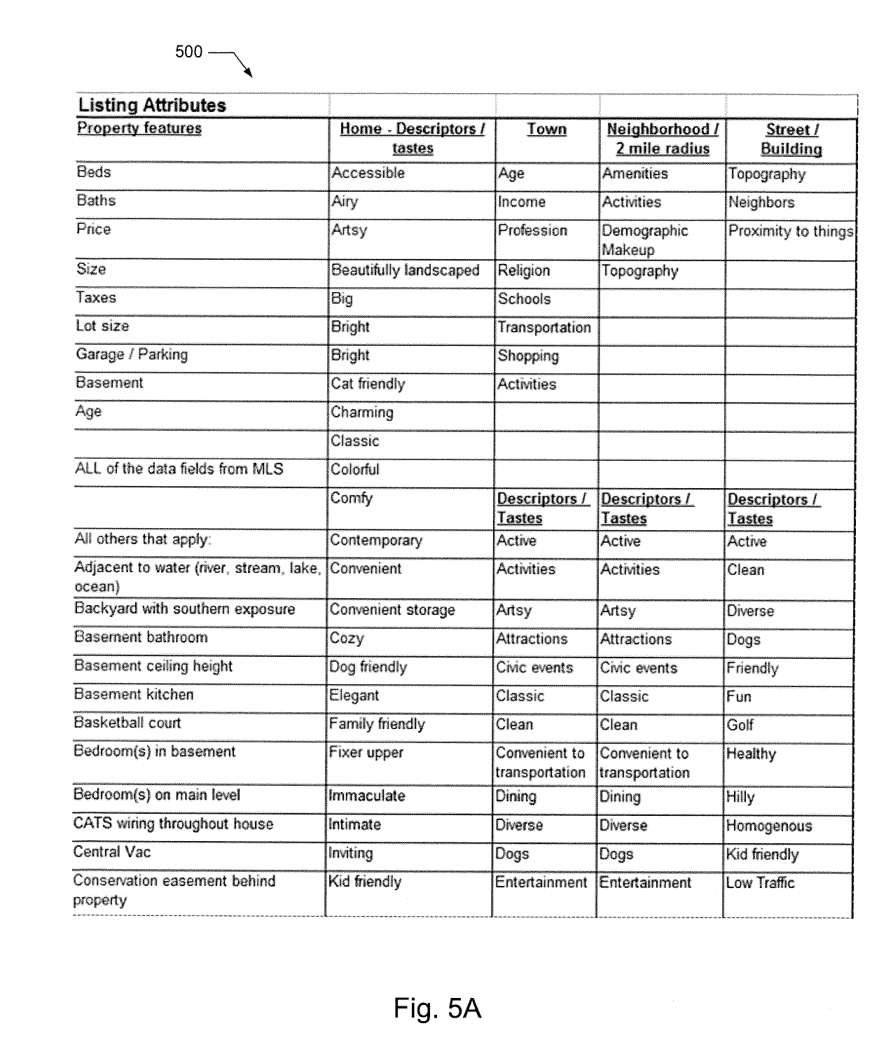

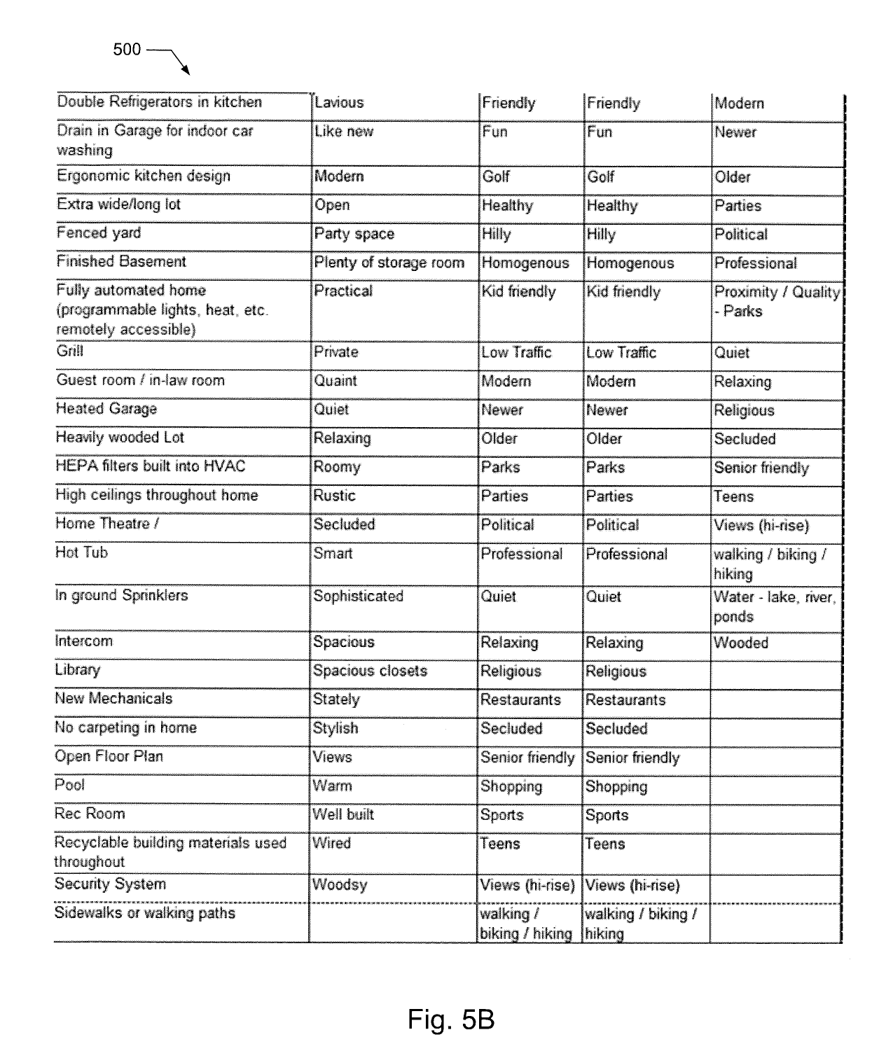

Real estate (i.e., listing) attributes may include a number of bedrooms, a number of bathrooms, a price, a home size, a tax amount, a lot size, a parking size, a basement indicator, an age, and/or any other suitable real estate attributes. Additional examples of real estate attributes 500 are shown in FIG. 5A and FIG. 5B.

Buyer attributes may include age, gender, family size, pets, hobbies, preferences, and/or any other suitable buyer attributes. Additional examples of buyer attributes are shown in Table 1.

TABLE 1
Buyer Attributes

```
Demographic
    AGE
    Gender
    Sexual orientation
    Profession
    Ethnicity
    Marital Status
    Family size
    Family lifecycle
    Generation (baby-boomers, Gen X, etc . . . )
    Income
    Occupation
    Education
    Nationality
    Religion
    Social Class
    Political Affiliation
Psychographic
    Hobbies
    Level Technical savvy
    Activities
    Interests
    Opinions
    Attitudes
    Values
    Lifestyle traits
    Health consciousness
Behavioralistic Attributes
    Decision making style
    Communication preference &/or style
    Benefits Sought
    Usage Rate
    Brand Loyalty
    User Status (potential, first-time, regular user, searcher,
    discriminator, etc . . . )
    Readiness to buy
    Occasions (Holidays and Events that stimulate an action or
    response)
    Preferred listing attributes
        always looks at pools,
        prefers cul-de-sac
        likes wooded area
        Large backyard, etc . . .
    Preferred advertisers (advertisers buyer responded to)
    Click stream history
    Time of day segmentation (late night user, lunch break user,
    etc . . . )
Life Events
Religion
Kids
Neighbors
Pets
Schools
Geography
    Current Address
    Target address or neighborhood
    Neighborhood similar to my own
    Rural vs. Urban
    Climate
    Population size/density
    Region
    New vs. old
Social Graph
    Who they shared listings with
    Who they “follow” listings of
    Extracted data from social networks
Proximity
    Want to live within 10 minutes from office
    Want to live at least 10 minutes from parents
    Close to public transportation
    Need a coffee shop nearby
```

In one embodiment, the knowledge database also includes attributes about advertisers that may choose to, for example, advertise goods or services to the buyers. Advertiser attributes may include geography, products, services, advertising budget, sales cycle, market share, and/or any other suitable advertiser attributes. Additional examples of advertiser attributes are shown in Table 2.

TABLE 2
Advertiser Attributes

```
Geography
Products
Services
Demographics of customers
Psychographics of customers
Average order size
Income/Revenue of Advertiser
Primary advertising methods
Ad budget
Seasonality of product/service
Industry
Financial health of advertiser
Company structure
Sales cycle
Sales channels/distribution model
Market Share
Customer acquisition cost
Financial metrics
Brand strength
Mission statement
Prior executed campaign
    Medium
    Cost
    success/failure
    target market/segmentation
Customer feedback
```

In one embodiment, the knowledge database also includes attributes about publishers that may choose to, for example, publish information about goods or services or the real estate properties. Publisher attributes may include geography, media type, products, services, circulation, industry, and/or any other suitable publisher attributes. Additional examples of publisher attributes are shown in Table 3.

TABLE 3
Publisher Attributes

```
Geography
Media
    Online
    Print
    TV
    Radio
    Signage
    Out of Home
    Digital Signage Networks (malls, elevators, Wal-Mart TV, etc.)
Products
    Magazine ads
    Online banner advertising
    Online content sponsorship
    TV commercials
    Radio spots
    Newspaper ads
    Product placement
    Direct marketing
    Classified advertising
    Sponsorships
    Trade show marketing
    Social media campaign
    email marketing
    SMS marketing
    Signage
    Ad Inventory sizes (full page, 30 seconds, screen takeover, etc.)
Services
    Market segmentation
    Creative services
    Media budget/buying
    Tracking of campaign effectiveness
    Printing
Demographics of audience
Psychographics of audience
Circulation
Reach
Frequency
Average Insertion Order ($) size
Revenue Model of Publisher (free, subscription, etc.)
Seasonality of product/service
Industry
Financial health of publisher
Company structure
Sales cycle (lead time, special events, frequency of publication, etc.)
Sales channels (online ad purchase, fax order in, sales rep, etc.)
Distribution model (free, delivery, online, over the air, etc.)
Market Share
Customer acquisition cost
Financial metrics
Brand strength
Mission statement
Prior executed campaign
    Medium
    Cost
    success/failure
    target market/segmentation
Customer feedback
```

In one embodiment, the knowledge database stores correlations between any combinations of the real estate attributes, buyer attributes, advertiser attributes, and publisher attributes. The knowledge database and correlations can be used to provide meaningful information about real estate listings in new and previously unexplored contexts. For example, based upon the knowledge database, a home with a dog run (a real estate attribute) may be advertised in a magazine about dogs (a publisher attribute). In another example, a family with three children (a buyer attribute) may be found to be highly correlated to homes with back yards (a real estate attribute).

In one embodiment, the recommendation system generates a correlation matrix that can identify levels of correlations among a wide variety of attributes. Using the correlation matrix, for example, a seller may be able to identify new correlations and exploit these correlations to sell more merchandise. Or, for example, an advertiser may advertise in a magazine based upon correlation data provided by the recommendation system. Or, for example, an advertiser may target new buyers via a particular magazine, via a particular television show based upon newly-identified correlations, or via custom targeted messages or ad copy.

In one embodiment, the correlation matrix can be used to not only identify correlations between attributes, but also to compare correlations with each other. For example, a magazine about dogs may use the correlation matrix to identify and rank correlations about not only dog runs, but nearby parks, neighbors, nearby restaurants, schools, and shops.

In one embodiment, the recommendation system uses prediction or estimation. In one embodiment, the recommendation system may estimate the interest that a particular home buyer may have in a particular property. The recommendation system may use this estimation to determine correlations. Or, the recommendation system may use correlation information from other sources to perform this estimation. Or, the recommendation system may use the estimate to determine how to advertise a certain property to a certain user. The recommendation system may use a weighted scores model to estimate the interest.

Or, the recommendation system may use regression models to predict the behavior of various users. The regression models may be user-centric, where the sample is all listings viewed by a specific user, or listing-centric, where the sample is all users that viewed a specific listing.

In one embodiment, the recommendation system may increase predictive accuracy by blending multiple predictors. In one embodiment, the recommendation system approaches blending as a linear regression problem. The solution in this type of recommendation system is the coefficients, or the weights, that should be given to each of the predictors in the ensemble.

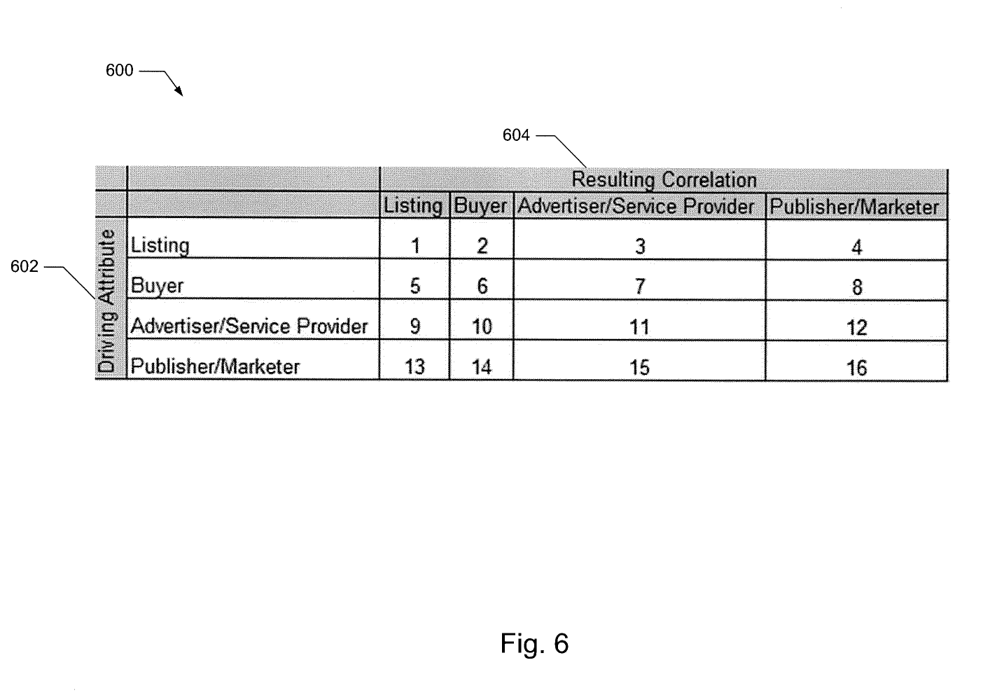

An example correlation matrix 600 showing sixteen correlation combinations is illustrated in FIG. 6. In one embodiment, buyers may be referred to as consumers because they are consumers of the real estate. The example correlation matrix organizes driving attributes 602 and resulting correlations 604. For example, the correlation matrix charts real estate attributes, buyer attributes, advertiser attributes, and publisher attributes against each other and places a correlation value that indicates the correlation between various attributes. In one embodiment, the recommendation system receives information about the driving attributes 602 listed vertically in matrix 600 and creates an “ideal” or optimized profile for a correlated listing, buyer, advertiser or marketer. Additional examples of correlations are shown in Tables 4 to 23.

Table 4 provides example data for an example Listing/Listing correlation.

TABLE 4
Listing/Listing

| a. | Similar Search - For buyers (buyers/sellers), agents, advertisers | |
|---|---|---|
| | who are searching real estate, find similar listings which correlate | |
| | highly with property attributes, including, but not limited to: | |
| | i. | Same Neighborhood (Lincoln Park, Chicago, IL), town |
| | | (Chicago), geography (north side) |
| | ii. | Similar Neighborhood (Lincoln Park, Chicago, IL), town |
| | | (Chicago), geography (north side) in other market (San |
| | | Francisco) |
| | iii. | Geography |
| | iv. | Price |
| | v. | Demographics of census tract |
| | vi. | Lot size |
| | vii. | Unique listing features (pool, tennis court, etc.) |
| | viii. | Square Footage |
| | ix. | Style of home |
| | x. | Proximity to desirable neighborhood features (train station, |
| | | coffee shop, parks, etc.) |

| | |
|---|---|
| b. | Competitive Market Analysis - use active and sold listing pricing to |
| | inform a decision on what price to set a new listing based on |
| | correlating similar non-price attributes (lot size, number of |
| | beds/baths, etc.) |

Table 5 provides example data for an example Listing/Buyer correlation.

TABLE 5
Listing/Buyer

| | |
|---|---|
| c. | Find a Buyer: For an agent or seller, define and/or find active buyers |
| | who would be interested in my listing to help target marketing of |
| | home. (Homes finding buyers) |
| d. | Social Network Pairing: For a buyer, find other active buyers looking |
| | at other homes with attributes I've either 1) expressed an interest in |
| | via actual listings; 2) provided indications of desired attributes; or 3) |
| | attributes assigned by the recommendation system based on |
| | correlations to known buyer information. |
| e. | Price matching - find buyers with financial constraints within the |
| | price point of the listing |

For example, a buyer may have a dog and want to be near a golf course. The recommendation system may use this information to build an optimized home based on these buyer attributes. This information will later inform the recommendations for that buyer. Or, based on homes a buyer looked at, a buyer may want to discover other prospective buyers to understand the competition, learn about other homes, or connect.

Table 6 provides example data for an example Listing/Advertiser correlation.

TABLE 6
Listing/Advertiser

| | |
|---|---|
| f. | Smart Matching Correlate attributes of a home and/or listing to |
| | products and services of advertisers. |

For example, if a listing has no or poor photographs with the listing, a photography company would target that seller/agent to use its services to promote the home's sale. Or, if a home built twenty years ago may need a new hot water heater, an advertiser may only want to target likely purchasers of hot water heaters. Or, a high end appliance manufacturer may only want to target display advertising on homes listed at over 1 million dollars. Or, hyper local advertisers may only want to target listings in a specific geography.

Table 7 provides example data for an example Listing/Publisher correlation.

TABLE 7
Listing/Publisher

| | |
|---|---|
| g. | House Finding a Buyer Attributes of a home correlate highly to the |
| | attributes of a publisher's publications' audiences |

For example, a house with a dog run may be advertised in Dog Fancy magazine, which attracts dog lovers. Or, home attributes may vary the description used with a given publisher.

Table 8 provides example data for an example Buyer/Listing correlation.

TABLE 8
Buyer/Listing

| h. | Life Events | |
|---|---|---|
| | i. | Children. |
| | ii. | Marriage. |
| i. | Psychographic Information | |
| j. | Demographic Information | |
| | i. | A buyer's demographic information (age, marital status, |
| | | family size, income, education level, etc.) will drive |
| | | correlations to certain property attributes (size, single |
| | | story/multi level, neighborhood, etc.) |
| k. | Online Behavior | |
| | i. | Use a buyer's online behavior to better correlate to attributes |
| | | of a home. |

| | |
|---|---|
| I. | Self Reporting - buyer attributes are learned from information they |
| | provide via a variety of tools, including widgets, surveys, games and |
| | direct questionnaires. |
| m. | Affordability - A buyer's financial condition that drive correlations to |
| | certain property attributes (price, location, amenities, etc . . . ) |

In one embodiment, the recommendation system may use attributes to create correlations that are useful in buying or selling homes. For example, a family with three children may be highly correlated to homes with backyards. A newly married couple may correlate to smaller homes or condos in a more urban setting. The recommendation system may also use psychographic information. For example, the recommendation system may contain information that a buyer is a biking enthusiast, learned from a variety of sources, including Google searches, social networks, magazine subscriptions, online purchases, or self reporting, which correlates highly with properties near forest preserves, parks, bike paths. For example, if a buyer looks at homes in Lake Forest, the recommendation system may become better informed about what other properties will be of interest. Or, if a buyer searches boating or fishing websites, the recommendation system may provide a high correlation of that buyer to homes on waterways.

Table 9 provides example data for an example Buyer/Buyer correlation.

TABLE 9
Buyer/Buyer

| | |
|---|---|
| n. | Buyers finding Sellers - use common attributes to find sellers |
| | who may have homes you like |
| o. | Buyers finding Buyers - For a buyer, find other active buyers |
| | looking at other homes with attributes that buyer has either |
| | 1) expressed an interest in via actual listings; 2) provided |
| | indications of desired attributes; or 3) attributes assigned |
| | by the recommendation system based on correlations to known |
| | buyer information. |
| p. | Socializing the sales/purchase process |
| q. | Peer Metrics about other participants with similar attributes to |
| | me |

| | |
|---|---|
| i. | How many homes are viewed? |
| ii. | How long is the average process? |
| iii. | Average mortgage rate? |
| iv. | Average purchase price? |
| v. | Average listing price to actual sales price achieved? |
| vi. | What are the most active months for searching, viewing |
| | and closing purchases? |

For example, based on homes a buyer looked at, the buyer wants to discover other prospective buyers to understand the competition, learn about other homes, or connect. Or, users may comment on various vendors or experiences to help others make decisions or avoid pitfalls.

Table 10 provides example data for an example Buyer/Advertiser correlation.

TABLE 10
Buyer/Advertiser

| | |
|---|---|
| r. | Smart Matching Correlate attributes of a buyer to products and |
| | services of advertisers |
| s. | Life Events |

| | |
|---|---|
| i. | Children. |
| ii. | Marriage. |

| | |
|---|---|
| t. | Psychographic Information |
| u. | Demographic Information |

| | |
|---|---|
| i. | A buyer's demographic information (age, marital status, |
| | family size, income, education level, etc.) will drive |
| | correlations to certain products and services advertisers |

| | |
|---|---|
| v. | Online Behavior |

| | |
|---|---|
| i. | Use a buyer's online behavior to better correlate to |
| | attributes of an advertiser. |

| | |
|---|---|
| w. | Self Reporting - buyer attributes are learned by information they |
| | provide via a variety of tools, including widgets, surveys, games |
| | and direct questionnaires which can inform advertiser targeting. |

In one embodiment, the recommendation system may be used in association with a marketing campaign to market homes to buyers. For example, a high end appliance manufacturer may choose to target display advertising to buyers searching for homes listed at over 1 million dollars. Based on campaign results, a high end appliance manufacturer may only want to target display advertising to buyers over 35 years old and searching for homes listed at over 1 million dollars. Or, a high end appliance manufacturer may only want to target display advertising to buyers who have previously viewed or saved refrigerator-related content. Or, hyper local advertisers may only want to target listings in a specific geography.

Alternatively, a family with three children may be highly correlated to advertisers targeting buyers of children/infant products. Or, a newly married couple will correlate to advertisers of financial services, home goods, appliances, and vacation planning. Or, for example, the recommendation system may contain information that a buyer is a biking enthusiast, learned from a variety of sources, including Google searches, social networks, magazine subscriptions, online purchases, or self reporting, which correlates highly with advertisers of sporting goods, bike shops, or adventure travel.

Or, the recommendation system may recognize that new families are of interest to certain sellers of baby products. Or, older buyers selling their home may be of interest to advertisers targeting retirement living.

For example, a buyer looks at homes in Lake Forest, which correlates highly with advertisers who operate businesses in Lake Forest. Or, a buyer searches boating or fishing websites, which would correlate higher to advertisers of boats, boating equipment, water-based vacation travel, etc. The frequency and timing in which a buyer looks at listings within a period of time may correlate to their position in the buyer lifecycle, which becomes an attribute against which advertisers can target. The recommendation system may identify buyers that looked at homes with pools, add that as an attribute of the buyer, and provide opportunities for advertisers to market specifically to those buyers that looked at pools.

Or, for example, a buyer indicates via viewed photographs that they are interested in high end kitchens. Advertisers of such goods and services would want to target this buyer based on these attributes.

Table 11 provides example data for an example Buyer/Publisher correlation.

TABLE 11
Buyer/Publisher

| | |
|---|---|
| x. | Buyer attributes will drive with which Publishers the |
| | recommendation system partners for implementing an automated |
| | marketing plan |
| y. | Buyer attributes will drive with which Publishers services are |
| | advertised |

For example, buyers who commute more than 30 minutes to work from home would lead to billboard advertising. Based on campaign results, the recommendation system may add buyers who have a newer model car and commute at least 30 minutes to work.

Table 12 provides example data for an example Advertiser/Listing correlation.

TABLE 12
Advertiser/Listing

| | |
|---|---|
| z. | Match attributes of advertiser audience/product/service to |
| | correlated attributes of the listing. |

For example, a financial services advertiser may want to advertise alongside high cost listings. Home Improvement advertisers seek properties older than 10 years. Based on campaign results, Home Improvement advertisers may seek properties older than 15 years but not older than 20 years. Or, orthopedic surgeons may target homes with marble floors, staircases, pool decks, etc.

Table 13 provides example data for an example Advertiser/Buyer correlation.

TABLE 13
Advertiser/Buyer

| | |
|---|---|
| aa. | Match attributes of advertiser audience/product/service to |
| | correlated attributes of the buyer. |

For example, Starbucks may target phone users searching homes near their stores. Or, KinderCare targets buyers with young children. The recommendation system may provide for customer segmentation. For example, the recommendation system may suggest diaper discounts to young families and high end goods to high income families.

For example, a local tennis club targets buyers who have a high health conscience cohort and are looking at homes in their market. Or, long distance movers target buyers moving over 200 miles. Or, a lawn care provider who closed 60% of leads sent by recommendation system targeting homeowners with lawns greater than ⅛ acre may create a new campaign targeting homeowners with lawns greater than ¼ acre.

Table 14 provides example data for an example Advertiser/Advertiser correlation.

TABLE 14
Advertiser/Advertiser

| | |
|---|---|
| bb. | Advertisers want to advertise alongside their competitors ( ) |
| cc. | Advertisers want to advertise alongside advertisers of |
| | complementary goods/services. |
| dd. | An advertiser of window treatments wants to target buyers who |
| | responded favorably to a campaign by an advertiser of new |
| | window. |

For example, Visa may want to advertise everywhere MasterCard advertises. Or, Chuck E Cheese advertises near KinderCare.

Table 15 provides example data for an example Advertiser/Publisher correlation.

TABLE 15
Advertiser/Publisher

| | |
|---|---|
| ee. | Match attributes of advertiser audience/product/service to |
| | correlated attributes of the Publisher. |

| | |
|---|---|
| i. | Promote listings (advertisements) in publications read by |
| | agents or home buyers |
| ii. | Based on data from the recommendation system, a pool |
| | service company would want to advertise in media with |
| | prior success in reaching pool owners. |

Table 16 provides example data for an example Publisher/Listing correlation.

TABLE 16
Publisher/Listing

| | |
|---|---|
| ff. | The publisher's ability to accept certain data/media will dictate |
| | what listing data is sent to the publisher. |

For example, YouTube only accepts video and limited text data, so no pictures can be sent or suggested in a system-generated marketing campaign.

Table 17 provides example data for an example Publisher/Buyer correlation.

TABLE 17
Publisher/Buyer

| | |
|---|---|
| gg. | A publisher's content will attract a certain segment of buyers |
| | attracted to that subject matter. |
| hh. | Based on the results of an ad campaign with a given publisher, |
| | the recommendation system iterates its advertising copy to better |
| | target the publisher's audience. |

For example, a listing is advertised as targeting dog owners in the classified section of the Chicago Tribune, and based on the buyers who responded, the listing copy is modified to better highlight the large backyard and nearby Dog Park.

Table 18 provides example data for an example Publisher/Advertiser correlation.

TABLE 18
Publisher/Advertiser

| | |
|---|---|
| ii. | Recommendation system results from prior campaigns become |
| | attributes that an advertiser would find value in when designing |
| | their ad campaigns. |

| | |
|---|---|
| i. | Recommendation system indicates that the responding |
| | audience for X magazine has a definitive set of attributes |
| | which would attract an advertiser. |

Table 19 provides example data for an example Publisher/Publisher correlation.

TABLE 19
Publisher/Publisher

| | |
|---|---|
| jj. | Recommendation system results from prior campaigns with |
| | competitive publishers become attributes that a publisher would |
| | find value in when targeting advertisers or other publishers to |
| | join together in a campaign. |

For example, a prior ad campaign in Time magazine results in successful campaigns for financial service companies. Newsweek would want that information to target new advertisers since their audience is similar.

Or, for example, prior marketing campaigns have a high correlation of success when both ads in the Chicago Tribune and signage are used together, which would inform later campaigns generated in association with the recommendation system.

Or for example, based on prior campaigns in Time magazine, quarter page ads were found to be the most effective. Newsweek would want that information to better sell similar products.

Table 20 provides example data for an example Listing/Buyer/Publisher correlation.

TABLE 20
Listing/Buyer/Publisher

| | |
|---|---|
| kk. | The attributes of a listing highly correlate with certain attributes |
| | of a buyer. That buyer attributes correlate highly with the |
| | attributes of a publisher's audience. |

For example, a home on a golf course is listed for sale. Such homes attract buyers who have a high household income, enjoy outdoor activities, and have at least two children. Golf Digest's audience comprises readers with similar attributes, so Golf Digest is included as a possible publisher of advertisements for this listing. Based on the results of the Golf Digest ad campaign, the recommendation system identifies a finished basement as another listing attribute highly desired by these buyers. Based on these learnings, a marketing campaign used with the recommendation system is modified to add banner ads in HGTV.com's remodeling section, which is a publisher attracting this segment of buyer.

Or, based on the results of the Golf Digest ad campaign, the recommendation system identifies additional buyer attributes of Golf Digest readers, which include interest in exotic travel. Based on these learnings, a marketing campaign used with the recommendation system is modified to add travel content sites as possible publishers.

Or, for example, a property is listed with partial information, including only a single photo. Three weeks later, additional data and photography are added, and a different set of buyers attracted to the listing is revealed, and their attributes are the basis for creating or modifying the publishers suggested in the marketing campaign.

Or, for example, a one bedroom condo in a downtown converted loft is listed. Such homes attract single, professional young adults. Such buyers are active smart phone users. Advertising this listing on mobile ad networks on real estate related mobiles sites would be suggested in a marketing campaign for this listing.

Table 21 provides example data for an example Listing/Buyer/Advertiser correlation.

TABLE 21
Listing/Buyer/Advertiser

| | |
|---|---|
| II. | The attributes of a listing highly correlate with certain attributes |
| | of a buyer. Those buyer attributes correlate highly with the |
| | attributes of an advertiser. |

For example, a home with an outdoor pool is listed for sale. Such homes attract buyers who have a high household income and enjoy outdoor activities. Frontgate, a high end home goods catalog, targets customers that like outdoor activities, and homeowners with outdoor pools. Based on the results of the Frontgate ad campaign, the recommendation system identifies the finished basement as another listing attribute highly desired by these buyers. Based on these learnings, the advertiser now advertises alongside listings with finished basements.

Or, for example, based on the results of the Frontgate ad campaign, the recommendation system identifies an additional attribute of buyers who respond to Frontgate's ads. That attribute is a family size of at least two children. Based on these learnings, the ad system will serve Frontgate ads to buyers with this additional attribute.

Or, for example, a property is listed with partial information, including only a single photo. Three weeks later, additional data and photography are added, and a different set of buyers attracted to the listing is revealed, and their attributes are the basis for attracting different advertisers.

Table 22 provides example data for an example Buyer/Listing/Advertiser correlation.

TABLE 22
Buyer/Listing/Advertiser

| | |
|---|---|
| mm. | The attributes of a buyer highly correlate with certain |
| | attributes of a listing. Those listing attributes correlate highly |
| | with the attributes of an advertiser. |

For example, buyers who have a high household income and enjoy outdoor activities have a high correlation with homes listed for sale with an outdoor pool. Frontgate, a high end home goods catalog, targets advertising on home listings with pools when a buyer that likes outdoor activities is looking at it. Based on the results of the Frontgate ad campaign, the recommendation system identifies an additional attribute of buyers who respond to Frontgate's ads when shown on listings with pools to buyers that enjoy outdoor activities. That attribute is a family size of at least two children. Based on these learnings, the ad system will serve Frontgate ads on listings with pools when buyers who enjoy outdoor activity and have a family size of at least two children view the listing.

Or, for example, based on the results of the Frontgate ad campaign, the recommendation system identifies the finished basement as another listing attribute highly desired by these buyers. Based on these learnings, the advertiser now advertises alongside listings with finished basements.

Or, for example, a buyer with no known income starts using the recommendation system. Three weeks later, additional behavior, correlations, or data is provided to discern the income of the buyer. A different set of listings, advertisers, or both are correlated to the new data. As a result, more targeted advertising and better recommendations are achievable.

Table 23 provides example data for an example Buyer/Listing/Publisher correlation.

TABLE 23
Buyer/Listing/Publisher

| | |
|---|---|
| nn. | Based upon the attributes of buyers looking at a particular |
| | listing, a publisher can be selected with an audience that matches |
| | the attributes of the buyers looking at the listing. |

For example, a bachelor is searching homes for sale. The recommendation system correlates the attributes of the bachelor and the types of homes he is looking at. Based upon these correlations, the system takes the bachelor's correlated attributes and finds a publisher with an audience with the same attributes.

Or, for example, a group of bachelors have been searching homes for sale. The system correlates the attributes of the bachelors and the types of homes they are looking at. Based upon these correlations, the system takes the bachelors' correlated attributes and finds a publisher with an audience with the same attributes.

Referring back to FIG. 3, the recommendation system generates correlations between the first real estate attributes and the first buyer attributes (block 304). The real estate attributes from the listing and/or the augmentation data may include a number of bedrooms, a number of bathrooms, a price, a home size, a home descriptor (e.g., charming), and/or any other suitable real estate attributes (see FIGS. 5A-5B). The real estate agent may augment the listing with additional attributes.

In one embodiment, the recommendation system then generates a knowledge database storing the processed real estate information, the first real estate attributes, and the first buyer attributes (block 306). In one embodiment, the recommendation system then receives second buyer attributes about an active buyer (block 308). For example, an active buyer looking to purchase a new home may enter his or her information into a web site implementing the recommendation system. In response to receiving the second buyer attributes, update the knowledge database based upon the second buyer attributes (block 310). The recommendation system then determines an optimized real estate profile based upon the updated knowledge database and the second buyer attributes (block 312). The recommendation system then presents the optimized real estate profile to the active buyer (block 314).

Or, the knowledge database may be updated after a property is sold. For example, if a real estate property is sold to a buyer, the buyer's profile may be used and integrated into the knowledge database. In one embodiment, the recommendation system can create better correlations—and thus provide better results—as more buyer attributes and real estate attributes are added to the knowledge database. In one embodiment, each successful real estate transaction can be used as a data point to enhance the accuracy and reliability of the recommendation system. In one embodiment, real estate transactions that fail—e.g., a sale is almost finalized but is then canceled when the prospective buyer decides to move into a home closer to a body of water—may also be used to update and modify the knowledge database.

It should be appreciated that after the recommendation system determines an optimized home profile, the recommendation system can search the knowledge database or other data sources for real estate that matches the optimized home profile. In one embodiment, the recommendation system allows a user to specify the match level in returning prospective real estate. For example, a user may specify that he would like a list of prospective real estate properties that are a 50% match of the optimized home profile. Or the user may be able to specify that the recommendation system returns only those prospective real estate properties that have attributes that match 90% or more of the optimized home profile.

Once the knowledge database is updated, the recommendation system may iterate through a new or adjusted real estate profile. Many iterations, taking in to account many different correlations between real estate attributes, buyer attributes, advertiser attributes, and publisher attributes, may occur.

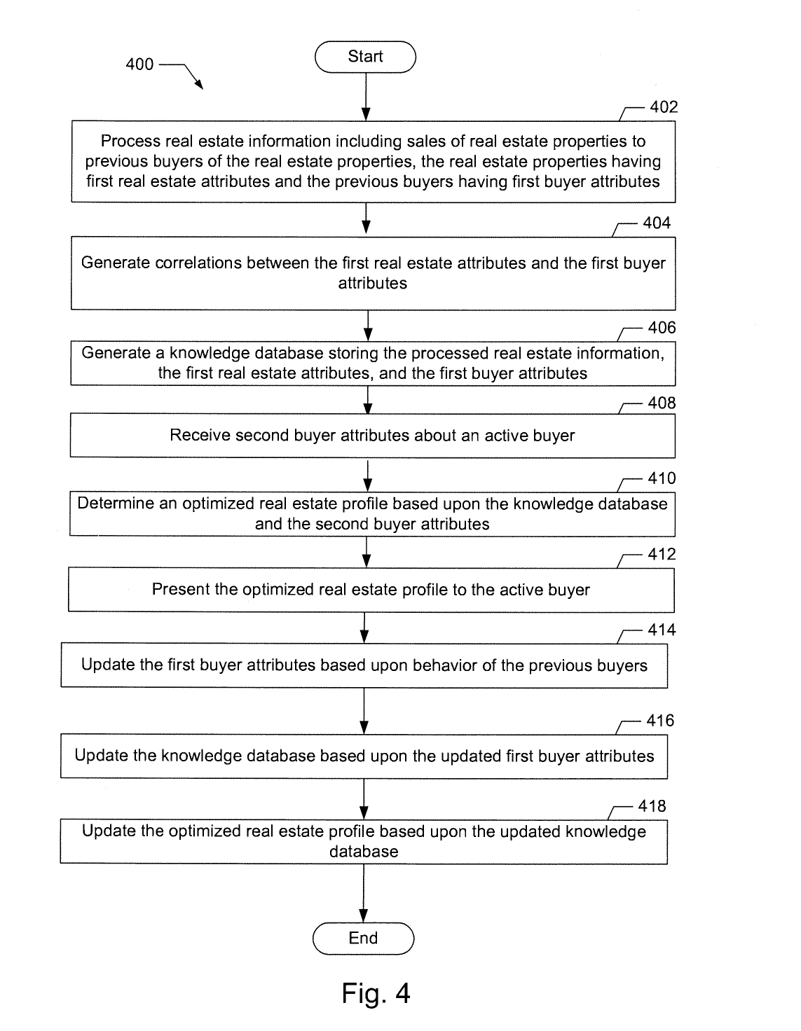

A flowchart of an example process 400 for presenting an optimized real estate profile is illustrated in FIG. 4. Preferably, the process 400 is embodied in one or more software programs which is stored in one or more memories and executed by one or more processors. Although the process 400 is described with reference to the flowchart illustrated in FIG. 4, it will be appreciated that many other methods of performing the acts associated with process 400 may be used. For example, the order of many of the steps may be changed, and many of the steps described are optional.

Steps 402 to 408 of process 400 are similar to steps 302 to 308, respectively, of process 300. The recommendation system then determines an optimized real estate profile based upon the knowledge database and the second buyer attributes (block 410). The recommendation system then updates the first buyer attributes based upon behavior of the buyers (block 412). The recommendation system then updates the knowledge database based upon the updated first buyer attributes (block 414). The recommendation system then updates the optimized real estate profile based upon the updated knowledge database (block 416).

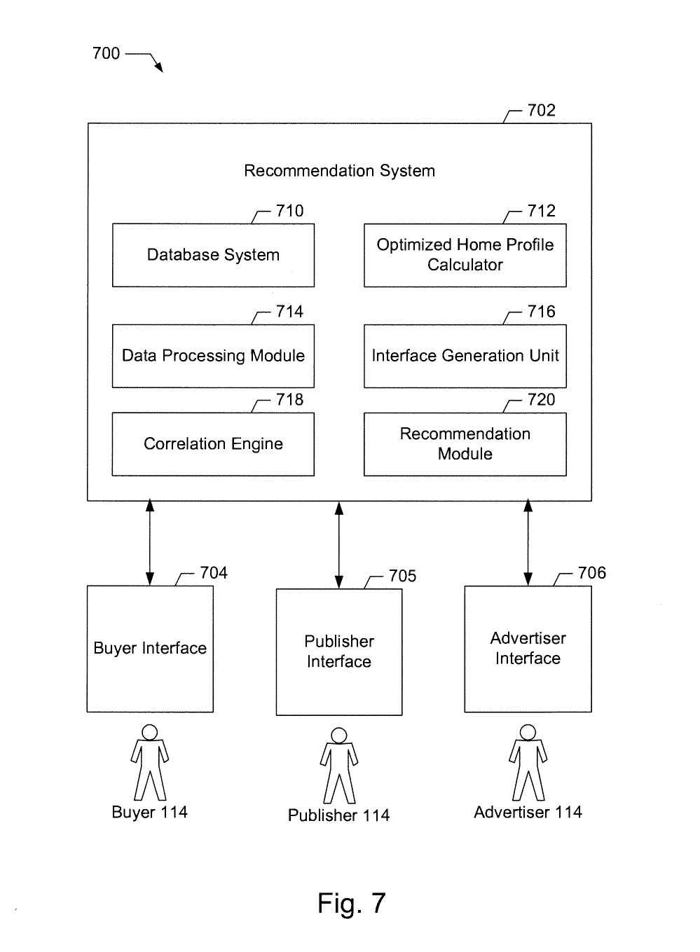

FIG. 7 is a block diagram showing an example recommendation structure 700 which includes a recommendation system 702, a buyer interface 704, a publisher interface 705, and an advertiser interface 706. The example recommendation system 702 may be implemented on one or more host devices 104 accessing one or more servers 108, 226. In an example embodiment, the recommendation system 702 includes a database system 710, an optimized home profile calculator 712, a data processing module 714, an interface generation unit 716, a correlation engine 718 and a recommendation module 720.

A user 114 may be, for example, a buyer that interacts with the buyer interface 704. A database system 710 may include a wide variety of data about real estate transactions and attributes.

An optimized home profile calculator 712 may provide information about an optimized home profile to a specific buyer. A data processing module 714 may be used to analyze, parse, and process the wide variety of data available to the recommendation system.

Interface generation unit 716 may provide, for example, HTML files that are used at the buyer interface 704, publisher interface 705, and advertiser interface 706 to provide information to the users 114. It should be appreciated that buyer interface 704, publisher interface 705, and advertiser interface 706 may be considered to be part of the recommendation system 702, however, for discussion purposes, the buyer interface 704, publisher interface 705, and advertiser interface 706 may be referred to as separate from the recommendation system 702.

For example, a user 114 may interact with a buyer interface 704 to research and review real estate properties. Or, a user 114 may interact with an advertiser interface 706 to advertise properties, merchandise, and services.

In one example embodiment, the recommendation structure 700 may include a publisher interface 705 for publishers to input and review information about publishing within the recommendation system or reaching other users 114 via publishing.

The optimized home profile calculator 712 may process data sent by the buyer interface 704, publisher interface 705, and the advertiser interface 706. The optimized home profile calculator 712 may also rely on data from database system 710. The optimized home profile calculator 712 may also process information collected by the data processing module 714 and the correlation engine 718 to prepare an optimized home profile for a buyer, described in further detail below.

The recommendation module 720 may use the data collected from buyer interface 704, publisher interface 705, and advertiser interface 706 and in the knowledge database to generate and present real estate recommendations.

It should be appreciated that the buyer interface 704, publisher interface 705, and advertiser interface 706 may look similar and have similar functionality, but have some portions that look different and behave differently for different users. The buyer interface 704, publisher interface 705, and advertiser interface 706 may also provide options for purchasing memberships or registering with an ID and a password. Registered users may have more access to information and more functions available than non-registered users. In one example embodiment, one integrated interface may provide access to buyer interface 704, publisher interface 705, and advertiser interface 706. For example, a service provider that provides optimized home profiles and recommendations may own a website that includes buyer interface 704, publisher interface 705, and advertiser interface 706.

Accordingly, buyer interface 704, publisher interface 705, and advertiser interface 706 may provide a wide range of information, for example, based on any searches or queries performed by a user 114.

It should be appreciated that certain functions described as performed, for example, at recommendation system 702, may instead be performed locally at buyer interface 704, publisher interface 705, and advertiser interface 706. It should be appreciated that the buyer interface 704, publisher interface 705, and advertiser interface 706 may be implemented, for example, in a web browser using an HTML file received from the recommendation system 702. In an example embodiment, buyer interface 704, publisher interface 705, and advertiser interface 706 may be located on a website, and may further be implemented as a secure website. Employees and employers may view match results on secure web pages, requiring a login ID and a password, that can only be accessed by authorized users. Also, buyer interface 704, publisher interface 705, and advertiser interface 706 may require a local application, for example, which a use may pay for to have access to, for example, information from the recommendation system 702 such as results output by the optimized home profile calculator 712.

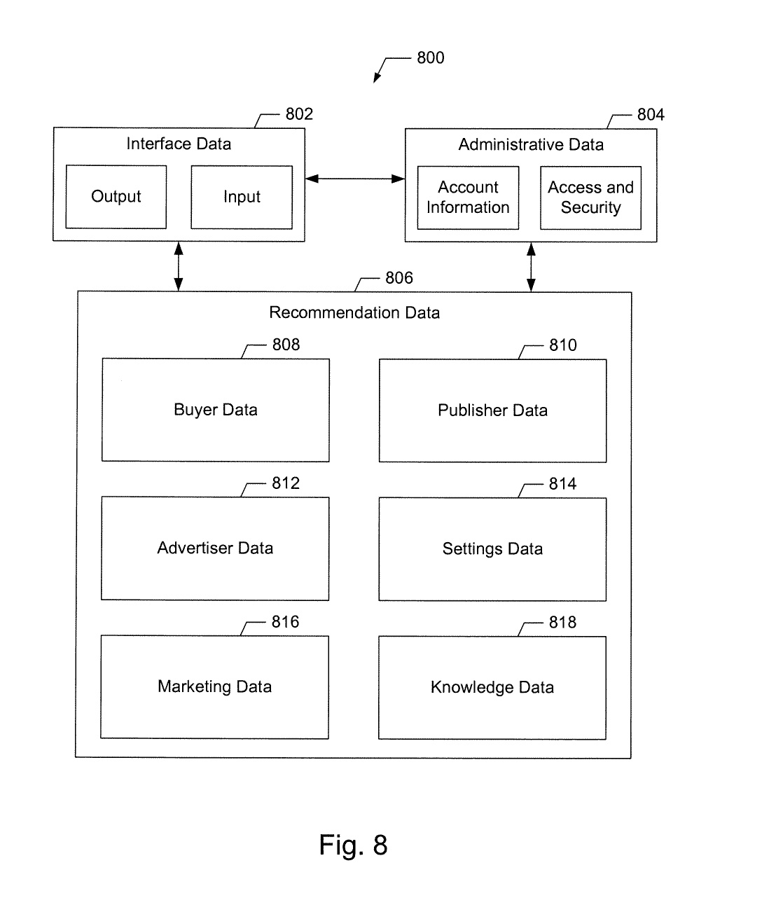

FIG. 8 illustrates a block diagram of an example data architecture 800. In the example data architecture 800, interface data 802, administrative data 804, and recommendation data 806 interact with each other, for example, based on user commands or requests. The interface data 802, administrative data 804, and recommendation data 806 may be stored on any suitable storage medium (e.g., server 226). It should be appreciated that different types of data may use different data formats, storage mechanisms, etc. Further, various applications may be associated with processing interface data 802, administrative data 804, and recommendation data 806. Various other or different types of data may be included in the example data architecture 800.

Interface data 802 may include input and output data of various kinds. For example, input data may include mouse click data, scrolling data, hover data, keyboard data, touch screen data, voice recognition data, etc., while output data may include image data, text data, video data, audio data, etc. Interface data 802 may include formatting, user interface options, links or access to other websites or applications, and the like. Interface data 802 may include applications used to provide or monitor interface activities and handle input and output data.

Administrative data 804 may include data and applications regarding account information and access and security. For example, administrative data 804 may include information used for as creating or modifying buyer accounts or publisher accounts. Further, administrative data 804 may include access data and/or security data. Administrative data 804 may interact with interface data 802 in various manners, providing a user interface 704, 705, 706 with administrative features, such as implementing a user login, password, and the like.

Recommendation data 806 may include, for example, buyer data 808, publisher data 810, advertiser data 812, settings data 814, recommendation data 816, and/or knowledge data 818. Buyer data 808 may include information about or actual buyers, such as name, age, education, work experiences, etc. Publisher data 810 may include information about publishers, such as name, industry, print magazines, etc. Advertiser data 812 may include information about advertisers, such as name, location, affiliations, brand strategy, etc. Settings data 814 may include information about the settings for a recommendation system, such as correlation matrix information, attributes being correlated, etc. Recommendation data 816 may include information about the real estate recommendations generated by the recommendation system. Knowledge data 818 may include information about various attributes, correlations, information about real estate listings, geographic data, etc.

It should be appreciated that data may fall under multiple categories of recommendation data 806, or change with the passage of time or circumstance. It should also be appreciated that recommendation data 806 may be tailored for a group of users, for example, if a new user joins the recommendation system as a buyer, the publisher data 810, advertiser data 812, settings data 814, recommendation data 816, and knowledge data 818 may change.

The integration of the various types of recommendation data 806 received from the buyer interface 704, publisher interface 705, and advertiser interface 706 may provide a synergistic and optimal resource for buyers, publishers and advertisers alike. In an example embodiment, a buyer looking to buy a home may benefit greatly from using an application in a mobile device 103 to receive information about an “ideal” home in real-time, based upon registering with and subscribing to a service website implementing the recommendation system.

Recommendation data 806 may be maintained in various servers 108, in databases or other files. It should be appreciated that, for example, a host device 104 may manipulate recommendation data 806 in accordance with the administrative data 804 and interface data 802 to provide requests or reports to users 114 including buyers, publishers and advertisers, and perform other associated tasks.

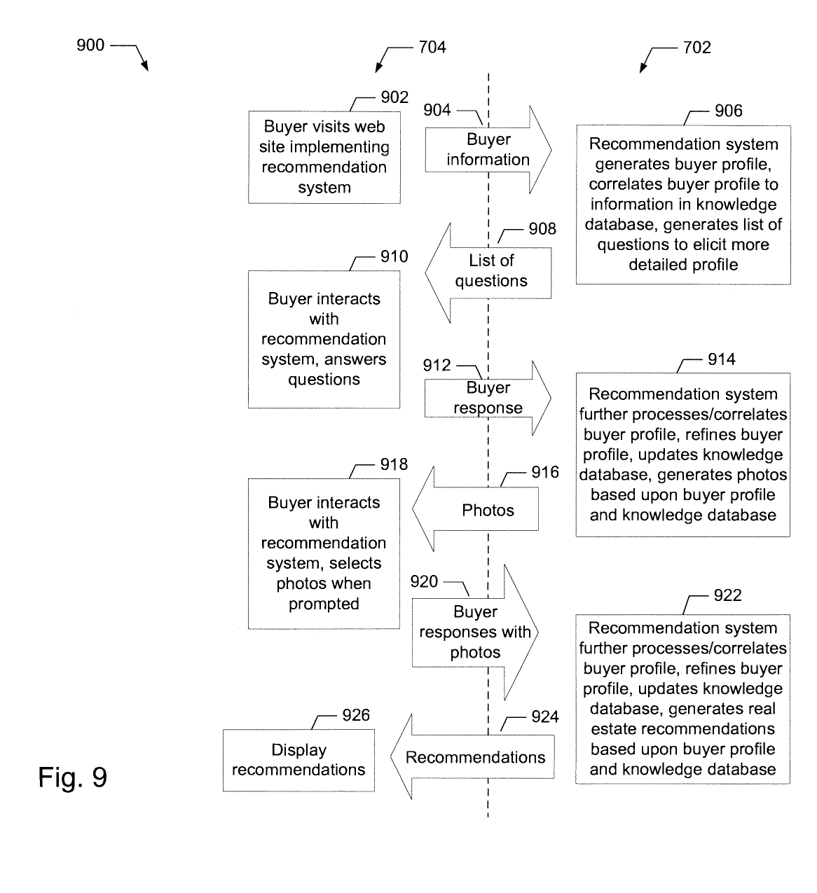

In one embodiment, the recommendation system generates, presents and refines recommendations based on iteratively receiving information from an active buyer. FIG. 9 is a flow diagram illustrating an example process 900 for generating real estate recommendations, according to an example embodiment of the present invention. Although the process 900 is described with reference to the flow diagram illustrated in FIG. 9, it will be appreciated that many other methods of performing the acts associated with the process 900 may be used. For example, the order of many of the blocks may be changed, certain blocks may be combined with other blocks, and many of the blocks described are optional.

In the example process 900, data may flow between the recommendation system 702 and a buyer interface 704. It should be appreciated that the recommendation system 702 may update the information stored in association with recommendation data 806. Accordingly, the recommendation system 702 information may remain current and/or provide sufficiently recent data for the benefit of all users.

The process 900 may begin with a buyer visiting a web site on a buyer interface 704 implementing recommendation system 702 (block 902). Recommendation system 702 begins to collect information about the buyer, such as the buyer interface's internet protocol (IP) address, cookies that are stored on the buyer's computer containing web usage information about the buyer, and any other information that the recommendation system 702 may have or have access to, to generate a buyer profile (block 904). For example, the recommendation system 702 may have information about the buyer from other databases and other sources.

Recommendation system 702 then generates a buyer profile, correlates the buyer profile to information in the knowledge database, and generates a list of questions to elicit more information and a more detailed profile (block 906). The recommendation system sends the questions to the buyer interface 704 (block 908). For example, based on the information about the buyer, such as the IP address, web site cookies, and information from other sources, the recommendation system 702 may ask the buyer questions about how many members are in the buyer's family, the reason the buyer is moving or looking for a new home, or the buyer's current residence.

The buyer then answers these additional questions (block 910). The buyer response data is then sent to the recommendation system 702 (block 912). The recommendation system 702 further processes and correlates the buyer profile, refines the buyer profile, and updates the knowledge database based upon the buyer response. The recommendation system 702 also generates photos based upon the updated buyer profile and the updated knowledge database (block 914). For example, the recommendation system 702 may send photographs to the buyer interface 704 and prompt the buyer as to which photographs the buyer prefers. The photograph data is sent to the buyer interface 704 (block 916).

When prompted, the buyer selects photographs he or she prefers (block 918). The buyer response, including data about the selected photographs, is sent to the recommendation system 702 (block 920). The recommendation 702 system further processes and correlates the buyer profile, refines the buyer profile, and updates the knowledge database. The recommendation system 702 also generates real estate recommendations based upon the updated buyer profile and updated knowledge database (block 922). For example, the recommendation system 702 may generate a set of properties or listing recommendations for this particular buyer based upon the updated knowledge database, including correlations between the buyer's profile and responses and data about other buyers in the knowledge database. The recommendation system sends the recommendations (block 924) to the buyer interface 704, which displays the recommendations (block 926).

It should be appreciated that the recommendation system in one embodiment iteratively receives information about a buyer in cycles. Each cycle elicits more information from the buyer that helps refine and improve the recommendation. The questions or information elicited often depend on the answers from previous questions. As discussed above, in each of blocks 906, 914, and 922, the recommendation system 702 may update the knowledge database in the database system 710 based on the information received from the buyer.

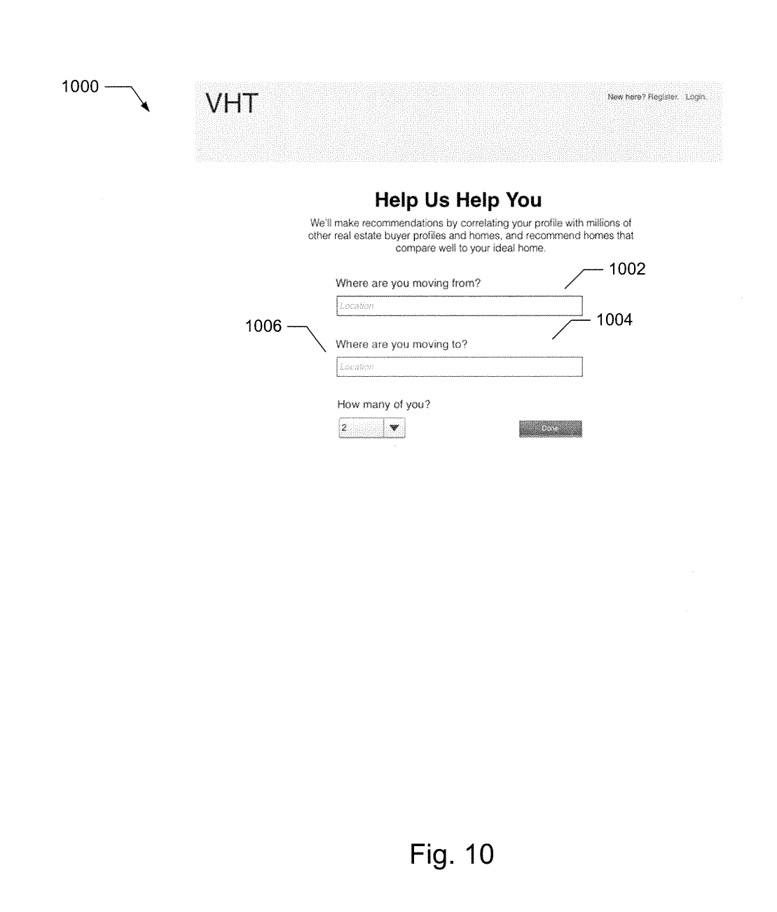

FIGS. 10 to 23 illustrate example screen shots of generating recommendations according to an example embodiment of the disclosed recommendation system.

FIG. 10 illustrates an example screen shot 1000 of a screen that a buyer may be presented when visiting a website that implements recommendation system 702. The recommendation system prompts the buyer as to where the buyer is moving from 1002 as well as where the buyer is moving to 1004. The recommendation system also asks the buyer how many people will be relocating 1006.

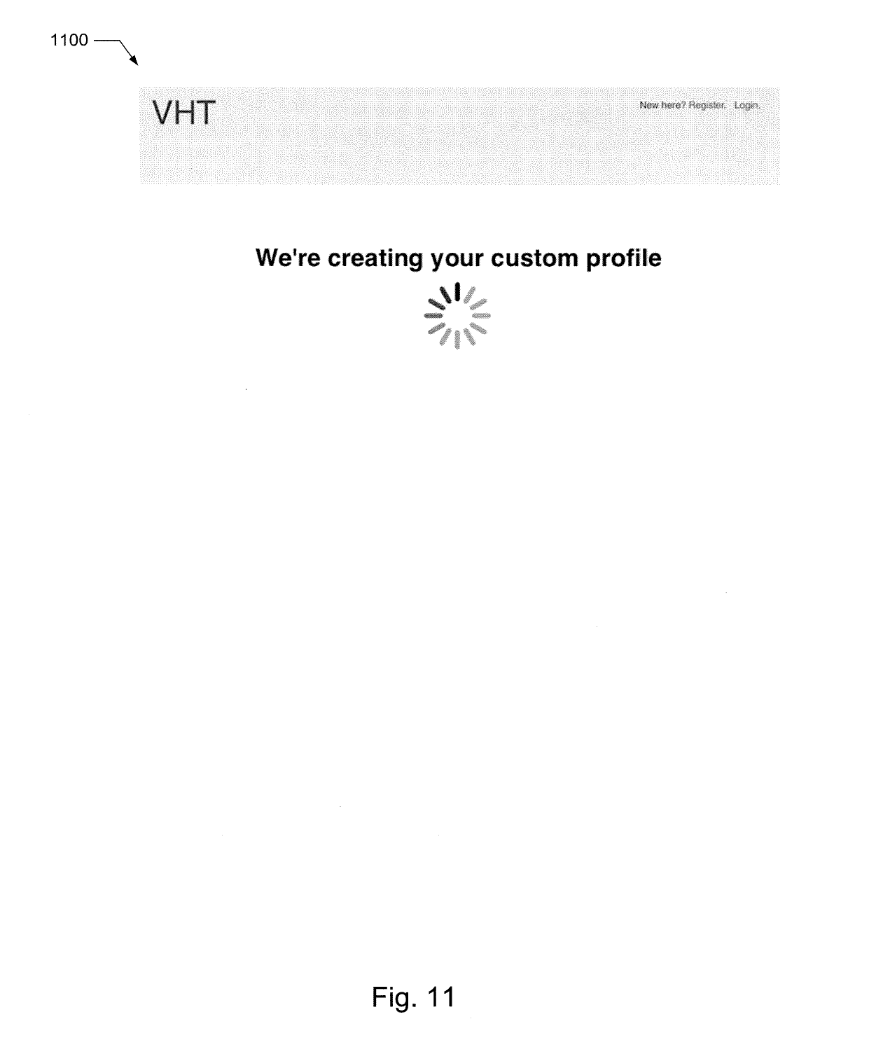

Based upon the buyer's responses, the recommendation system then begins to create a custom profile for the buyer as shown by example screen shot 1100 in FIG. 11. The profile created at this point may also include information about the buyer's internet protocol address, cookies, such as website cookies that track information about the buyer's web usage as well as any other data that the recommendation system may have about the buyer. The recommendation system correlates the information in the buyer profile with the knowledge database. In one embodiment, the recommendation system uses the correlation matrix to make correlations between the buyer profile and the knowledge database.

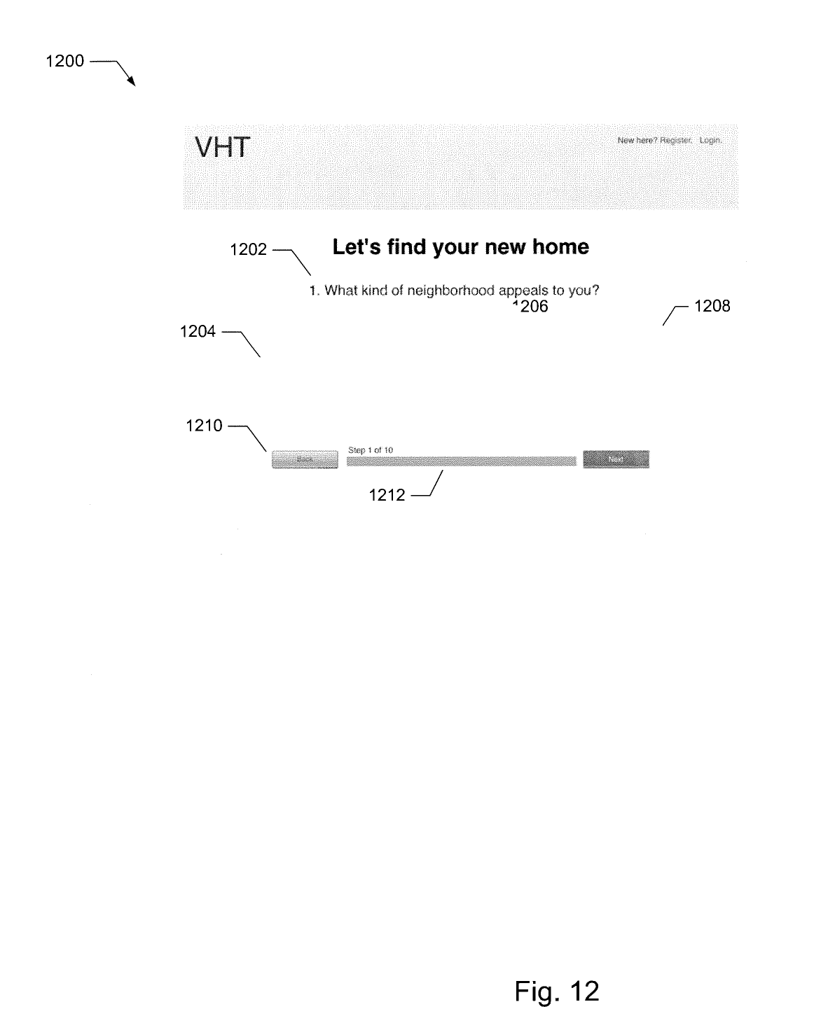

The recommendation system then prompts the buyer with additional questions that are associated with photographs. FIG. 12 is an example screen shot 1200 of prompting the buyer with additional questions and associated photographs. FIG. 12 may be used as a discovery tool, or used in a discovery phase, to learn additional details about the buyer. The recommendation system may ask the buyer what kind of neighborhood appeals to the buyer 1202. In one embodiment, there is no text associated with or explanation for any of the photographs. Instead, the recommendation system prompts the buyer with photographs, such as photographs 1204, 1206 and 1208, and the buyer is simply asked to choose a photograph of a neighborhood that appeals to that buyer.

The recommendation system may indicate to the buyer that the recommendation system is presenting a multi-step process, e.g., a ten step process 1210, and that the buyer is on the first step. The recommendation system may provide a progress bar 1212 so that the buyer knows of his or her progress as the buyer progresses through the discovery phase.

It should be appreciated that instead of the buyer simply entering his or her own search criteria and then being given results, the recommendation system iteratively elicits information from the buyer in cycles.

The cycles have a discrete number of steps and the buyer can interact with the recommendation system to uncover or discover what type of home that buyer would be most interested in or would best suit the buyer. The recommendation system takes the responses from the buyer and correlates them with data for the potentially hundreds or thousands or millions of transactions that are stored in the knowledge database.

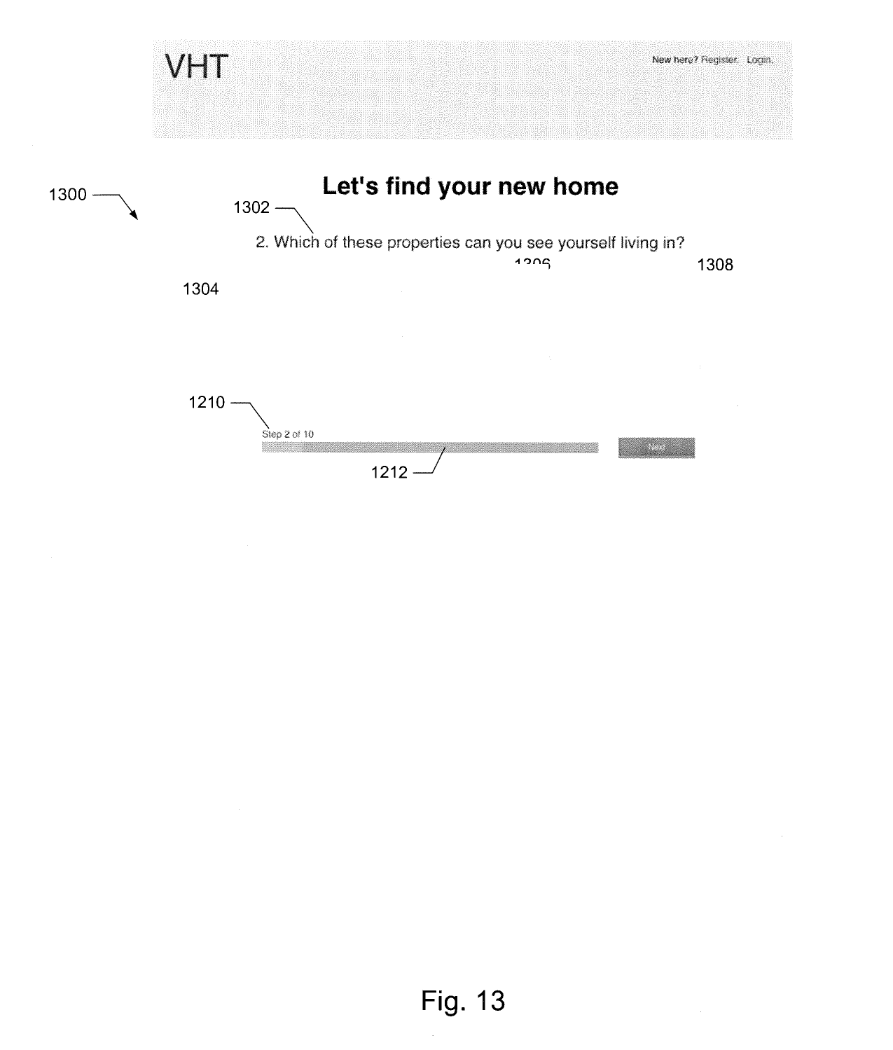

FIG. 13 illustrates an example screen shot 1300 of another question that is asked of the buyer. The recommendation system asks the buyer as to which of the presented properties can the buyer see him or herself living in 1302. Again, the buyer is presented with photographs 1304, 1306 and 1308. The buyer is again informed as to what step of the discovery process the buyer is in 1210 as well as a progress bar 1212. The buyer selects one or possibly more than one of the photographs.

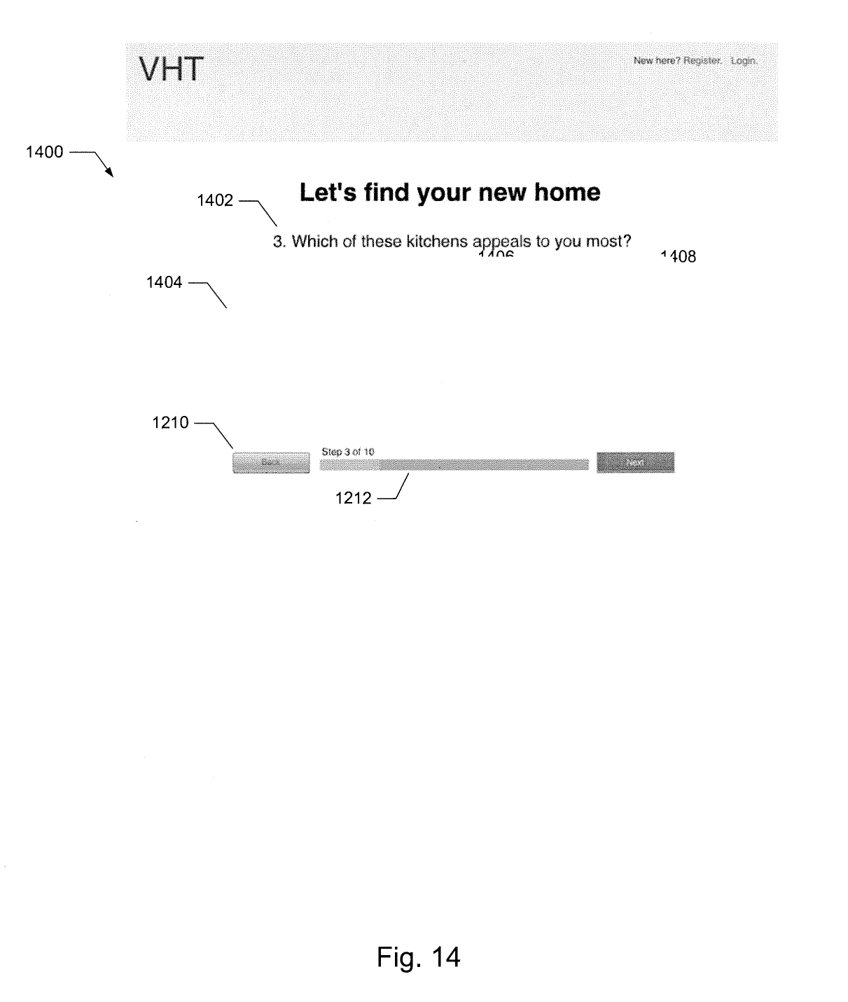

The website implementing recommendation system then presents FIG. 14, which illustrates an example screen shot 1400 of another question and associated photographs presented to the buyer. The question may be related to the types of kitchens that are in the knowledge database. The recommendation system asks the buyer as to which of the presented kitchens appeals most to the buyer 1402. The buyer is presented with photographs 1404, 1406 and 1408. Again, the buyer is presented with an indication as to the steps completed and remaining 1210 and a progress bar 1212.

It should be appreciated that although the photographs presented to the buyer are not accompanied by any specific text of explanation about that photograph, the recommendation system has a large amount of data and knowledge about each of the photographs. So for example, a buyer that selects photograph 1404 indicates to the recommendation system that a buyer prefers any one of a wide variety of aspects of features of photograph 1404. The data is culled and processed on the back end by recommendation system using the knowledge database and the correlation matrix discussed above so that each selection by the buyer translates into a large amount of data about that buyer's preferences. For example, in one embodiment, the buyer selecting one photograph may inform the recommendation system about fifteen or twenty data points regarding the buyer's real estate preferences.

It should also be appreciated that the buyer may in some instances be providing information regarding the buyer's real estate preferences to the recommendation system that even the buyer may not be have consciously identified as his or her own real estate preferences. The recommendation system can, for example, correlate a buyer who selects kitchen 1046 with a specific type of refrigerator even if the buyer may not be aware of that type of refrigerator.

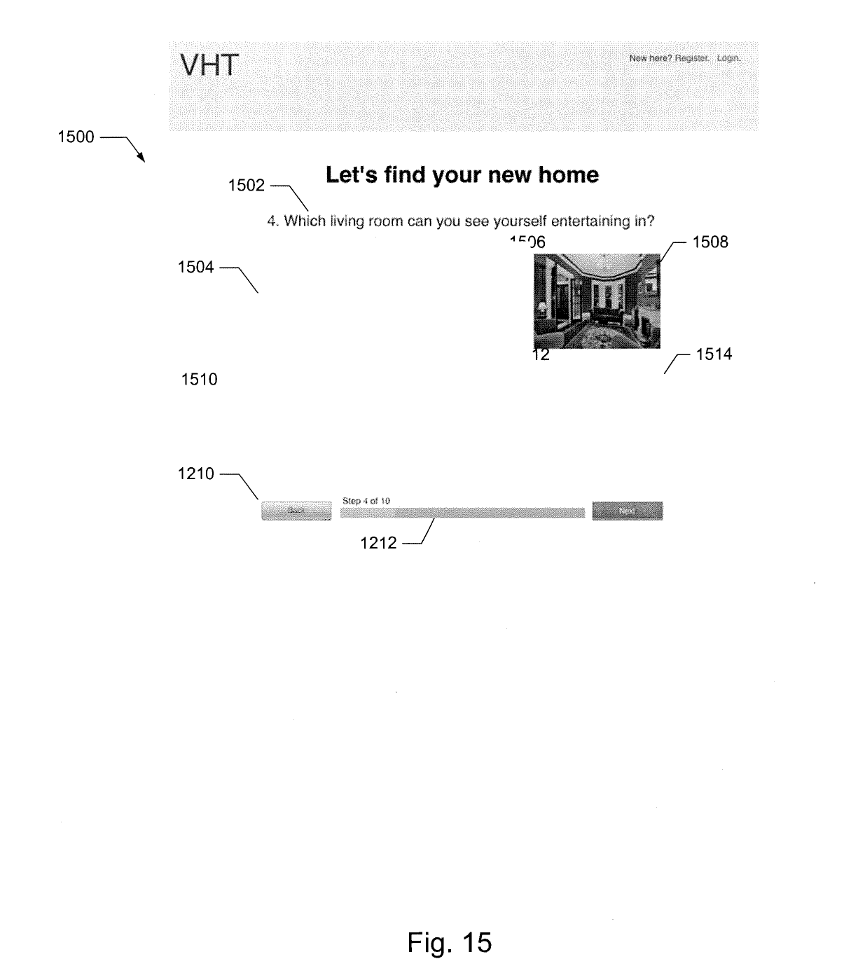

FIG. 15 illustrates an example screen shot 1500 and another question 1502 is presented to the buyer. The buyer is asked about a living room that he can see himself or herself entertaining in and is presented with six photographs, for example, 1504, 1506, 1508, 1510, 1512 and 1514. Again, the buyer is presented with the number of completed steps 1210 and a progress bar 1212 indicating the progress through a discovery phase of the recommendation system. As before, each photograph is associated with a large amount of real estate data.

It should be appreciated that in the series of questions during a discovery phase, the photographs that are presented in a question may depend on the answer to a previous question. For example, if the buyer selects photograph 1404 in FIG. 14, the photographs presented in FIG. 15 may be different than if the buyer selects photograph 1408 in FIG. 14. In one embodiment, the number of steps may not be indicated to the buyer because the recommendation system updates, in real time, the number of questions asked by the recommendation system. In other words, in one embodiment, the recommendation system decides after each question whether another question needs to be asked.

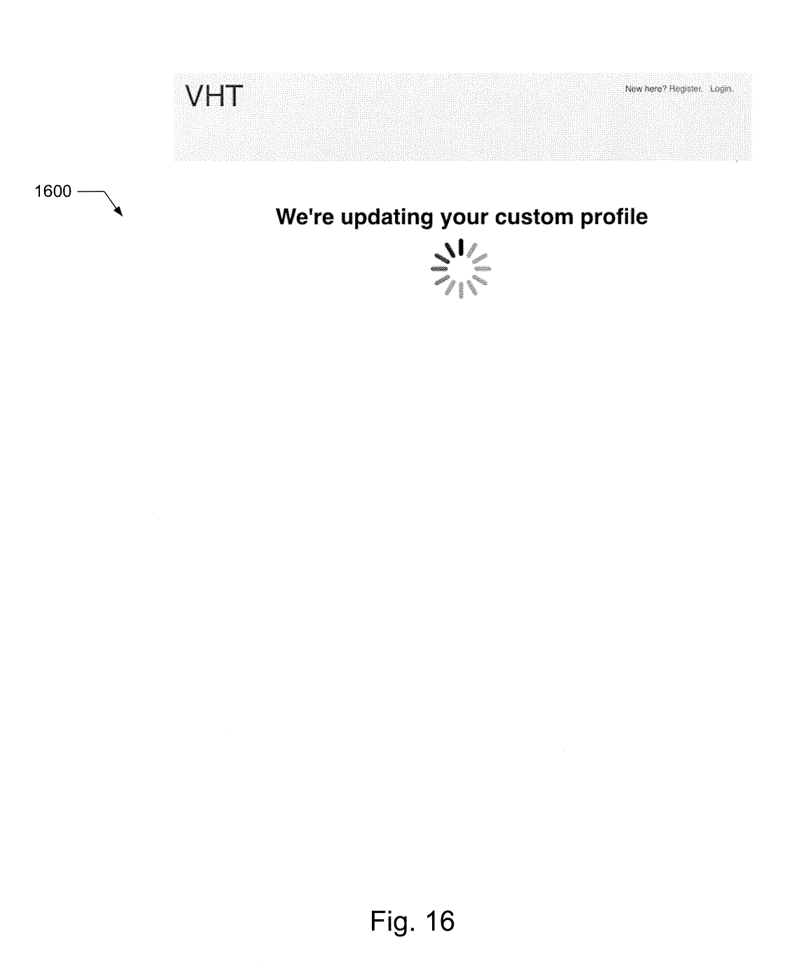

Once the series of photographs are presented to the buyer and the buyer has selected a response, the buyer is presented with FIG. 16, which illustrates an example screen shot 1600 indicating to the buyer that the recommendation system is updating the buyer's profile. The recommendation system then generates an updated buyer profile based on the information that the recommendation has collected from the buyer as well as information about the buyer that the recommendation system has from other data sources.

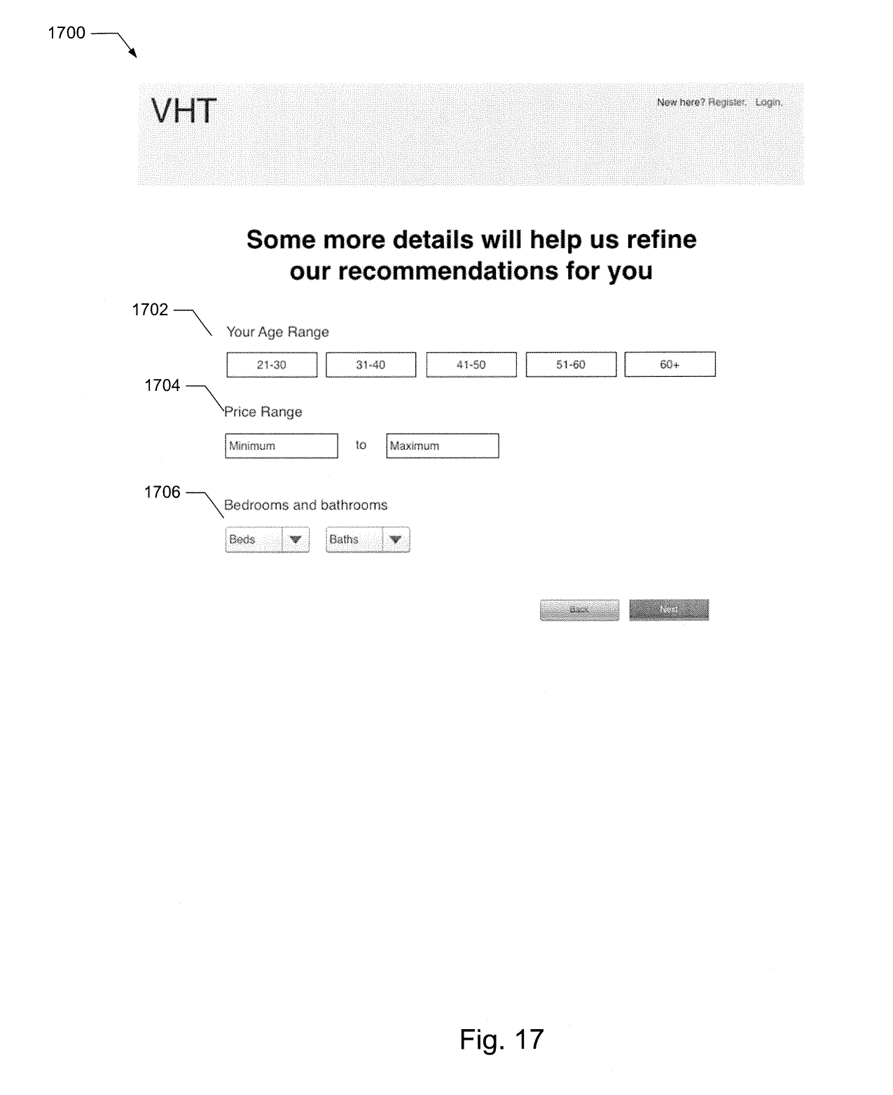

The recommendation system then presents another cycle of questions or discovery and asks the buyer additional questions. FIG. 17 illustrates example screen shot 1700 of asking for additional details to help generate and/or refine recommendations. The recommendation system asks the buyer his or her age range 1702 with options broken down into various groups for responding. The recommendation system also asks a price range 1704 allowing the buyer to enter a minimum and maximum range. The recommendation system also asks the number of bedrooms and bathrooms 1706.

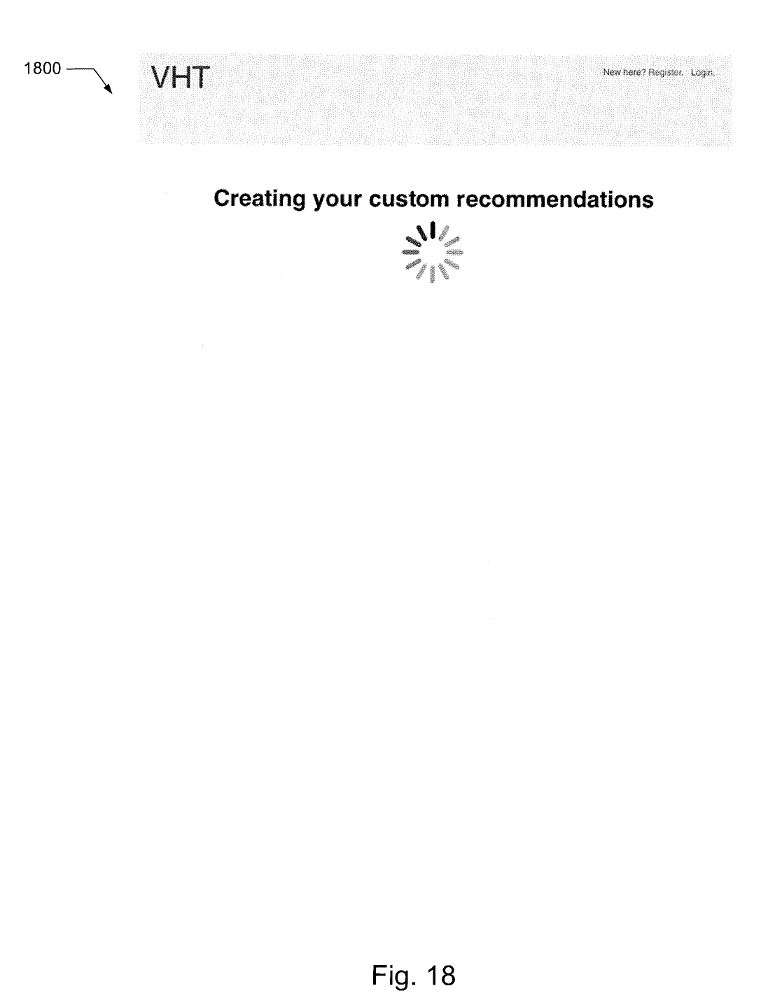

Once the buyer selects the responses in example screen shot 1700, the recommendation system again refines and/or updates the buyer profile and knowledge database. The recommendation system correlates the updated buyer profile with the updated knowledge database and creates custom recommendations as shown by example screen shot 1800 in FIG. 18.

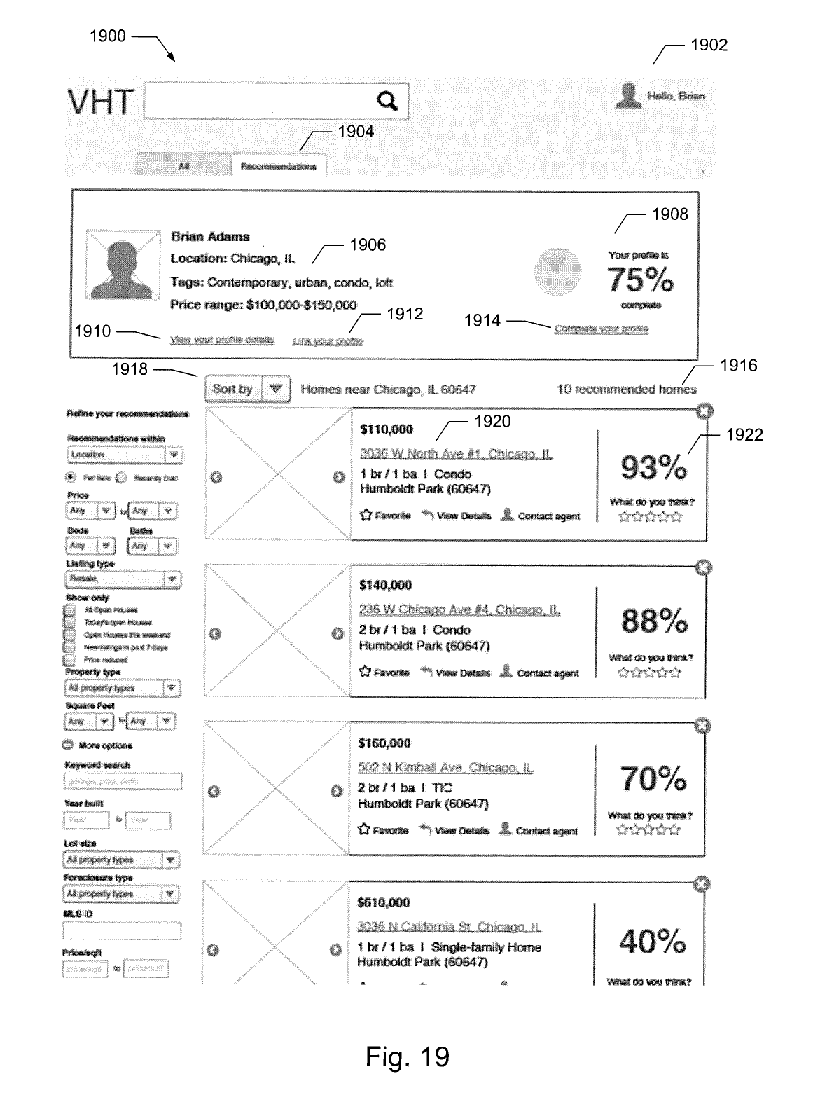

FIG. 19 is an example screen shot 1900 of presenting recommendations to the buyer based on the buyer profile. As shown in example screen shot 1900, the recommendation system has personalized or customized the recommendations for the specific buyer 1902 and presents the recommendations in a recommendation tab 1904. The recommendation system summarizes information about the buyer and the type of homes that the buyer is looking for 1906 such as location, tags, and price range. The tags in one embodiment present, for the first time, textual descriptions associated with the properties. In other words, the recommendation system converts the photographs selected by the buyer to categories describing features or aspects of real estate properties. The buyer may not even be aware of the features or aspects selected by the recommendation system. For example, the buyer may not have described his or her preference as a contemporary style, but based upon the buyer's selection of photographs, the recommendation system determines that the buyer is likely to prefer a contemporary style of home. The recommendation system indicates a profile completeness percentage 1908 informing the buyer that providing even more information would likely generate an even better recommendation for the buyer. The buyer may view his or her profile details 1910, link his or her profile with other websites 1912 or complete his or her profile 1914. It should be appreciated that if the buyer elects to complete his profile 1914, the recommendation systems refines the buyer profile, updates the knowledge database and also updates the recommendations based upon the new information about the buyer.

In one embodiment, the recommendation system updates the knowledge database and the recommendations to the buyer in real time in response to the buyer providing information to the recommendation system. In one embodiment, the recommendation system updates the knowledge database and recommendations to the buyer in response to other buyers providing information to the recommendation system. For example, if two buyers are using a website that implements the recommendation system, the knowledge database may take information that a first buyer provides and use that information in generating a recommendation for another buyer who is also using the recommendation system.

As shown in example screen shot 1900, the recommendation system provides a list of recommended homes 1916. The buyer may sort the recommendation list by various features such as homes near a specific city or zip code 1918.

In one embodiment, the recommendation system assigns a score to each real estate property based upon the level of correlation between the buyer profile and the real estate property. In one embodiment, the recommendation system generates an ideal home profile based upon the buyer profile and compares each real estate property in the knowledge database to the ideal home profile. The recommendation system then provides a score to each real estate property based upon the level of correlation between the ideal home profile and the real estate property. The recommendation system may also provide a score that depends on both the buyer profile and the ideal home profile.

The recommendation system provides a recommendation of a home 1920 and provides a score for that home 1922. The recommendations are listed in one embodiment with the highest score appearing first. So, for example, a home that scores 88% would appear after a home that scores 93%. It should be appreciated that the scoring system thus allows the recommendation system to granularly identify the best homes for a buyer.

The recommendation system may also provide an option for the buyer to provide feedback by asking the buyer what the buyer thinks of a home, as shown by feature 1922. The buyer can select one to five stars to indicate to the recommendation system whether or not the buyer agrees with the recommendation, one star indicating the lowest level of agreement and five stars indicating the highest level of agreement. The recommendation system adds the feedback from the buyer to the knowledge database and uses that data for correlations.

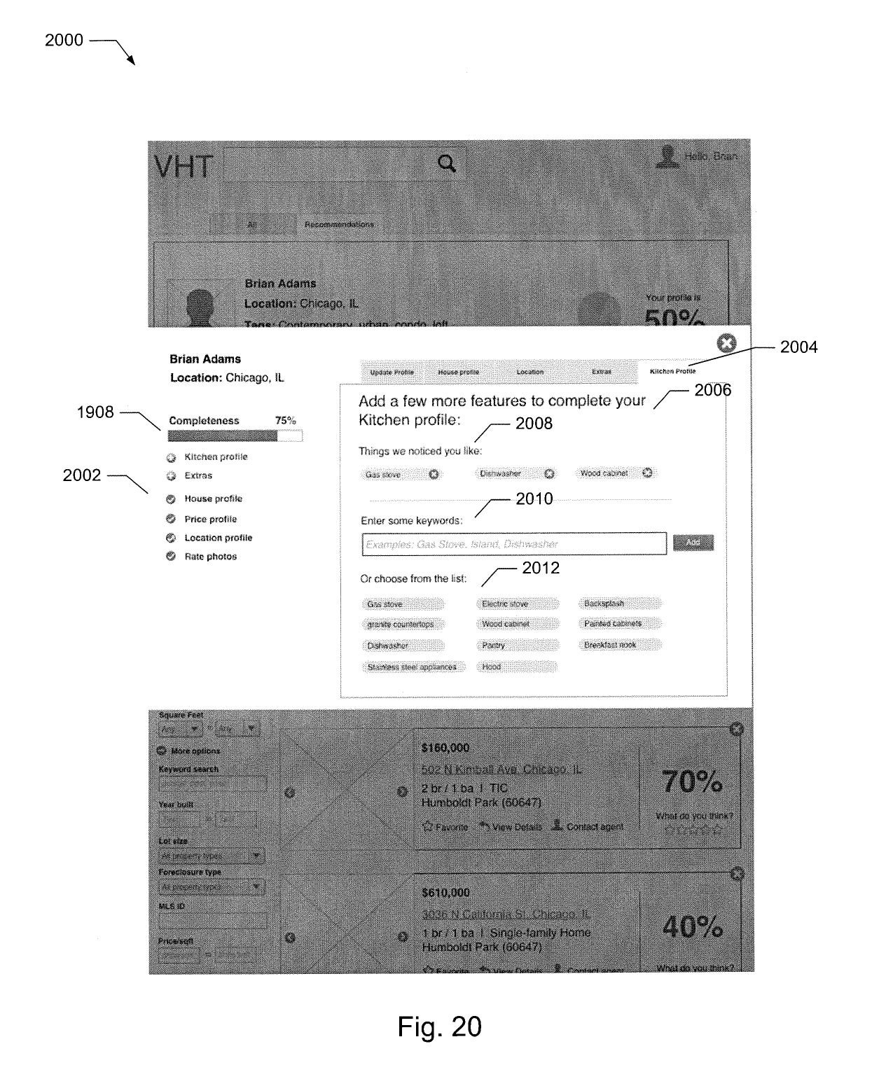

FIG. 20 illustrates an example screen shot 2000 of a buyer adding additional information to his or her profile after the recommendation system makes recommendations. The buyer is presented with a completeness percentage 1908. The buyer can see a list of the additional information 2002 he or she can provide to increase the completeness percentage 1908. The buyer is presented with several tabs including a kitchen profile tab 2004. Kitchen profile tab 2004 allows the recommendation system to specifically elicit information about a kitchen from the buyer. The recommendation system asks the buyer to add more features 2006 to complete a kitchen profile.

The recommendation system in one embodiment presents features that the buyer may prefer based upon correlation data from the knowledge database. For example, the recommendation system may determine, from processing the knowledge database and from correlation data based on the buyer profile that the buyer may like a gas stove, a dishwasher and wood cabinets 2008. These suggestions are gleaned together from the responses that the buyer has previously provided to the recommendation system. The recommendation system therefore provides additional options to the buyer based on the buyer's answers or the buyer profile. Or, the buyer may enter his or her own key words 2010 to complete a kitchen profile. Or, the buyer may choose additional features bout relating to a kitchen profile from a list 2012.

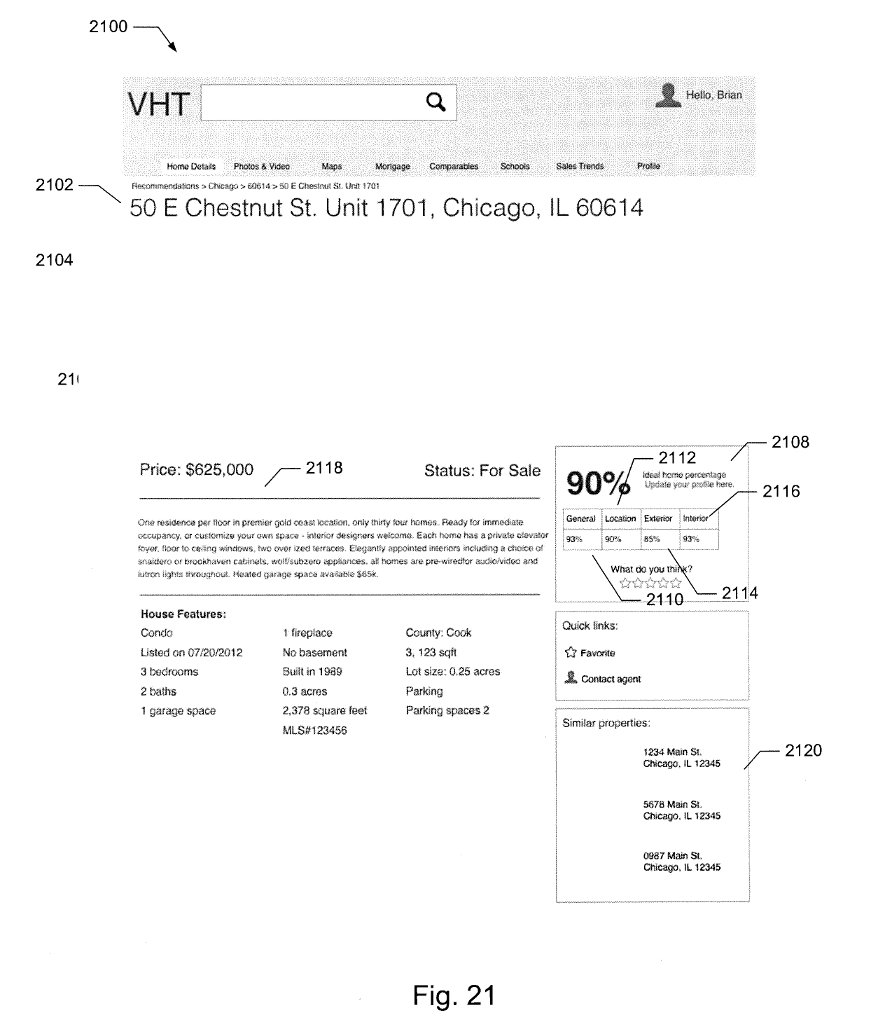

FIG. 21 is an example screen shot 2100 of additional details about a recommended property. The property in screen shot 2100 may be the top scoring or top recommended home.

The example screen shot 2100 provides an address 2102 for the recommended property and an area 2104 for images of the home and area 2106 for thumbnails of additional figures of the home. Example screen shot 2100 presents score 2108 that indicates an ideal home percentage to the buyer. The overall home percentage 2108 is also broken down into specific aspects of the home. Therefore the buyer views not only the overall score of a home, but also views the scores for individual sections or aspects of a home. For example, a buyer may also be presented with a general score 2110 of 93%, a location score 2112 of 90%, exterior score 2114 of 85% and an interior score 2116 of 93%. The buyer can again provide feedback about the score using a star system which informs the recommendation system as to the accuracy of its algorithms, its knowledge database, and its correlation matrix. It should be appreciated therefore that the recommendation system not only provides an overall ideal home percentage, but also provides percentages that correlate to different aspects of the home. This is advantageous in that a buyer who values the interior of a home more than a location will be able to use interior percentage versus location percentage to make a decision. For example, a first home may have a higher overall ideal home percentage or score than a second home, but the second home may have a higher interior score than the first home. The buyer is thus presented with very valuable data about the two homes, namely, that the recommendation system recommends the first home more than the second home, but the buyer has the power and knowledge to understand that the buyer may actually prefer the second home. By providing additional real estate data the recommendation system allows the buyer to make informed well-calculated decisions that take into account hundreds or thousands of real estate related variables. Example screen shot 2100 also presents additional information about the home to the buyer 2118 and also presents similar properties 2120.

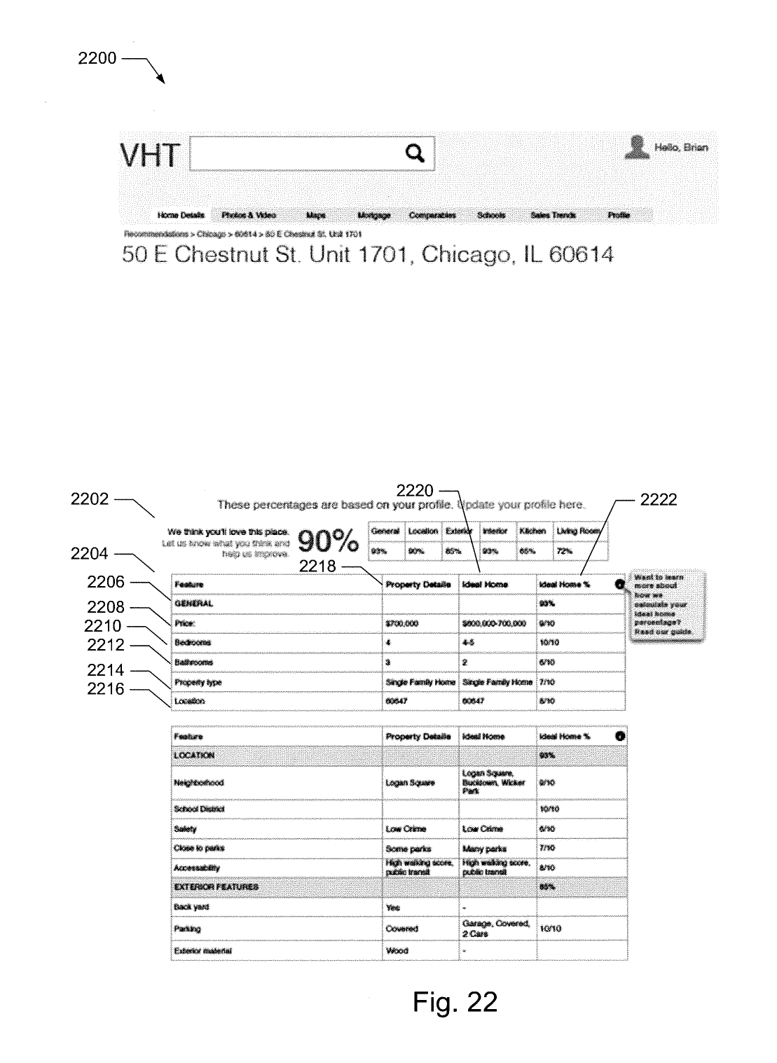

FIG. 22 is an example screen shot 2200 of additional information that may be presented to the buyer. Again, the recommendation system provides an overall score of a 90% 2202, but then also provides a breakdown of certain aspects of the home such as the general score, location score, exterior score and interior score, a kitchen score and a living room score. This allows the buyer not only to see which home matches his or her overall criteria or preferences, but also allows the buyer to see which homes match certain granular aspects of the home. The recommendation system also presents to the buyer a feature breakdown which compares each feature of the presented property with an ideal home profile and then provides an ideal home percentage.

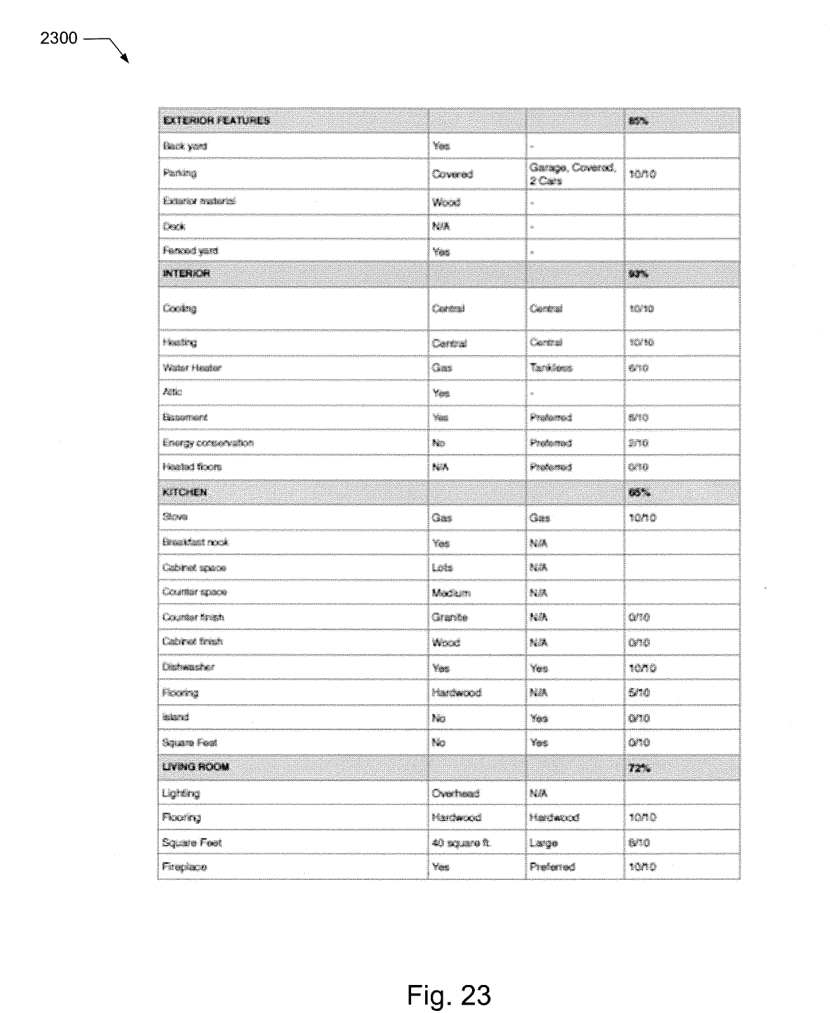

Feature breakdown 2204 is a feature breakdown that shows the general score, which includes a price 2208, number of bedrooms 2210, bathrooms 2212, property type 2214 and location 2216. For each aspect that makes up the general score, the recommendation systems provides a column that shows the property details 2218 for each aspect, the ideal home profile 2220 for that aspect and an ideal home percentage 2210 for that aspect. For example, feature breakdown 2204 shows that the presented home is worth $700,000 and the buyer's ideal home is $600,000-700,000. It also provides a comparison between the property's bedrooms and the bedrooms in the buyer's ideal home. It should be appreciated that the recommendation system provides a feature breakdown for location, exterior features, interior features, a kitchen, and a living room as shown in FIG. 22 and screen shot 2300 in FIG. 23.

It should be appreciated that although the discussion above generally refers to the sale and purchase of real estate properties, the embodiments disclosed herein may also be applicable to rental of real estate properties.

In summary, persons of ordinary skill in the art will readily appreciate that methods and apparatus for generating real estate recommendations have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of presenting real estate recommendations, the method comprising:
processing real estate information including sales of real estate properties to a first group of buyers of the real estate properties, the real estate properties having first real estate attributes and the first group of buyers having first buyer attributes;
generating correlations between the first real estate attributes and the first buyer attributes;
generating a knowledge database storing the processed real estate information, the first real estate attributes, and the first buyer attributes;
receiving second buyer attributes about an active buyer;
in response to receiving the second buyer attributes, updating the knowledge database based upon the second buyer attributes;
determining an optimized real estate profile based upon the updated knowledge database and the second buyer attributes; and
presenting the optimized real estate profile to the active buyer.

2. The method of claim 1, further comprising:
updating the second buyer attributes based upon behavior of the active buyer;
in response to updating the second buyer attributes, updating the knowledge database based upon the updated second buyer attributes; and
updating the optimized real estate profile based upon the updated knowledge database.

3. The method of claim 1, further comprising:
updating the first buyer attributes based upon behavior of the first group of buyers;
updating the knowledge database based upon the updated first buyer attributes; and
updating the optimized real estate profile based upon the updated knowledge database.

4. The method of claim 3, wherein the updating of the knowledge database based upon the updated first buyer attributes occurs in response to the updating of the first buyer attributes based upon the behavior of the first group of buyers.

5. The method of claim 1, wherein the second buyer attributes include past behavior of the active buyer.

6. The method of claim 5, wherein the past behavior includes an amount of time the active buyer spent looking at information about real estate properties.

7. The method of claim 1, wherein the second buyer attributes include first preference information associated with real estate properties reviewed by the active buyer.

8. The method of claim 7, wherein the preference information includes negative correlations associated with real estate properties disliked by the active buyer.

9. The method of claim 1, wherein the knowledge database includes reactions of the first group of buyers to images, wherein the images are photographs of real estate properties.

10. The method of claim 9, wherein the reactions of the first group of buyers to the images include the amount of time the first group of buyers spent looking at information about real estate properties.

11. The method of claim 1, wherein the active buyer includes multiple members of a family and wherein the second buyer attributes include second preference information associated with each member of the family.

12. The method of claim 1, further comprising comparing the optimized real estate profile to available real estate properties.

13. The method of claim 12, further comprising assigning a score to each available real estate property, the score indicating an amount of similarity between the optimized real estate profile and the respective available real estate property.

14. The method of claim 13, further comprising presenting any available real estate properties having at least a predetermined score.

15. The method of claim 13, wherein the optimized real estate profile includes an optimized room profile and the score indicates an amount of similarity between the optimized room profile and a room in the respective available real estate property.

16. The method of claim 14, further comprising comparing a first available real estate property to a second available real estate property.

17. The method of claim 14, further comprising ranking the available real estate properties based upon the score.

18. The method of claim 1, further comprising building a real estate property based upon the optimized real estate profile.

19. A method of presenting real estate recommendations, the method comprising:
processing real estate information including sales of real estate properties to first group of buyers of the real estate properties, the real estate properties having first real estate attributes and the first group of buyers having first buyer attributes;
generating correlations between the first real estate attributes and the first buyer attributes;
generating a knowledge database storing the processed real estate information, the first real estate attributes, and the first buyer attributes;
receiving second buyer attributes about an active buyer;
determining an optimized real estate profile based upon the knowledge database and the second buyer attributes;
presenting the optimized real estate profile to the active buyer;
updating the first buyer attributes based upon behavior of the first group of buyers;
updating the knowledge database based upon the updated first buyer attributes; and
updating the optimized real estate profile based upon the updated knowledge database.

20. The method of claim 19, wherein the behavior includes internet browsing history of the first group of buyers.

21. The method of claim 19, wherein the updating of the knowledge database based upon the updated first buyer attributes occurs in response to the updating of the first buyer attributes based upon the behavior of the first group of buyers.

22. A computing device for presenting real estate recommendations using a computer, the computing device:
processing real estate information including sales of real estate properties to a first group of buyers of the real estate properties, the real estate properties having first real estate attributes and the first group of buyers having first buyer attributes;
generating correlations between the first real estate attributes and the first buyer attributes;
generating a knowledge database storing the processed real estate information, the first real estate attributes, and the first buyer attributes;
receiving second buyer attributes about an active buyer;
in response to receiving the second buyer attributes, updating the knowledge database based upon the second buyer attributes;
determining an optimized real estate profile based upon the updated knowledge database and the second buyer attributes; and
presenting the optimized real estate profile to the active buyer.

23. A computing device for presenting real estate recommendations using a computer, the computing device:
processing real estate information including sales of real estate properties to first group of buyers of the real estate properties, the real estate properties having first real estate attributes and the first group of buyers having first buyer attributes;
generating correlations between the first real estate attributes and the first buyer attributes;
generating a knowledge database storing the processed real estate information, the first real estate attributes, and the first buyer attributes;
receiving second buyer attributes about an active buyer;
determining an optimized real estate profile based upon the knowledge database and the second buyer attributes;
presenting the optimized real estate profile to the active buyer;
updating the first buyer attributes based upon behavior of the first group of buyers;
updating the knowledge database based upon the updated first buyer attributes; and
updating the optimized real estate profile based upon the updated knowledge database.

24. A non-transitory computer readable medium storing software instructions for presenting real estate recommendations which, when executed, cause an information processing apparatus to:
process real estate information including sales of real estate properties to a first group of buyers of the real estate properties, the real estate properties having first real estate attributes and the first group of buyers having first buyer attributes;
generate correlations between the first real estate attributes and the first buyer attributes;
generate a knowledge database storing the processed real estate information, the first real estate attributes, and the first buyer attributes;
receive second buyer attributes about an active buyer;
in response to receiving the second buyer attributes, update the knowledge database based upon the second buyer attributes;
determine an optimized real estate profile based upon the updated knowledge database and the second buyer attributes; and
present the optimized real estate profile to the active buyer.

25. A non-transitory computer readable medium storing software instructions for presenting real estate recommendations which, when executed, cause an information processing apparatus to:
process real estate information including sales of real estate properties to first group of buyers of the real estate properties, the real estate properties having first real estate attributes and the first group of buyers having first buyer attributes;
generate correlations between the first real estate attributes and the first buyer attributes;
generate a knowledge database storing the processed real estate information, the first real estate attributes, and the first buyer attributes;
receive second buyer attributes about an active buyer;
determine an optimized real estate profile based upon the knowledge database and the second buyer attributes;
present the optimized real estate profile to the active buyer;
update the first buyer attributes based upon behavior of the first group of buyers;
update the knowledge database based upon the updated first buyer attributes; and
update the optimized real estate profile based upon the updated knowledge database.
